(19) United States
(12) Patent Application Publication
(10) Pub. No.: US 2016/0247245 A1
(43) Pub. Date: Aug. 25, 2016

(54) COMPUTER SYSTEM AND METHOD FOR PROVIDING A MULTI-USER TRANSACTION PLATFORM ACCESSIBLE USING A MOBILE DEVICE

(71) Applicant: DealTap Group, Inc., Toronto (CA)

(72) Inventor: Milan BAIC, Toronto (CA)

(21) Appl. No.: 15/027,291

(22) PCT Filed: Oct. 7, 2014
(86) PCT No.: PCT/CA2014/000729

§ 371 Date: Apr. 5, 2016

Related U.S. Application Data
(60) Provisional application No. 62/045,678, filed on Sep. 4, 2014.
(60) Provisional application No. 61/887,702, filed on Oct. 7, 2013.

(30) Foreign Application Priority Data
Oct. 7, 2013 (CA) 2829469

(51) Int. Cl. G06Q 50/18; G06Q 30/00; G06F 3/0354; G06F 21/62; G06F 3/0488; G06F 21/44; G06F 17/30

(52) U.S. Cl. CPC G06Q 50/188; G06F 21/44; G06Q 30/018; G06F 17/30719; G06F 17/30253; G06F 17/30598; G06F 21/6209; G06F 3/0488; G06F 3/03543

(57) ABSTRACT

A computer system is provided for managing one or more workflow associated with negotiating and concluding transaction documents, including (a) a plurality of computer terminals linked to a computer network, including computer terminals that are mobile devices, each computer terminal associated with an individual; and (b) one or more computers executing a computerized transaction workflow management system that provides a computer network that when executed enables: (i) interaction of users with transaction documents based on their permissions, based on their role in a transaction; (ii) negotiation of transaction documents between parties to the transaction by enforcing a series of negotiation rules associated with the transaction, while allowing the parties to view and sign transaction documents related to the transaction securely using the computer service; and (iii) tracking actions in relation to the negotiation and conclusion of transaction documents for the purposes of automatically generating information regarding the current status of negotiation and optionally also to generate audit information.

### CROSS-REFERENCE TO RELATED APPLICATIONS

This application claims priority to or otherwise claims the benefit of U.S. Provisional Patent Application 61/887,702, filed Oct. 7, 2013; U.S. Provisional Patent Application 62/045,678, filed Sep. 4, 2014; and Canadian Patent Application 2,829,469, filed Oct. 7, 2013; each of which are hereby incorporated by reference in their entireties.

### FIELD

The present disclosure relates to transaction platforms. The present disclosure further relates to web based platform for generating, exchanging, and signing documents.

### BACKGROUND OF INVENTION

In many environments, transactions are still entered into using paper based forms, particularly if their completion requires multiple steps and there are physical signature requirements (legal or regulatory). This is generally the case for example in the real estate industry, banking industry, or financial industry.

For example in the real estate industry, multiple signed documents are normally required in order to conclude for example the sale/purchase of a home. Moreover, the signed documents are normally negotiated, for example with offers and counter-offers. Also, multiple signatures are normally required, and are generally gathered by attending in person with the signatories of the documents. Keeping track of the current state of a proposed real estate transaction, with the changing conditions due to counter-offers for example, and then gathering the necessary signatures across the various required documents, can be very time consuming and also is often inconvenient for clients. Furthermore, the signed documents generally must then be delivered to the “other side(s)” in the negotiation for example from a real estate agent to a cooperating agent, who then delivers to his or her client. These processes are very time consuming and a digital age very cumbersome.

Similar problems exist in other industries that involve transactions requiring multiple signatures and multiple documents (that may involve a number of steps. before their negotiation is completed).

In numerous industries, approval of certain steps may be required, at certain stages of the negotiation of the documents.

It can be difficult and time consuming to keep track of the current status of multiple documents, and other steps required such as approvals.

In some industries or industry segments, documents are generated, changes are made (to the documents using for example a document processing system) or by making handwritten annotations, and signatures may be collected and exchanged using fax counterparts. In many cases multiple signature pages are then collated and stored in order to maintain evidence to support for example non-repudiation of an agreement. Paper documents are often stored to a document management system, and an audit trail is created, for example in order to meet compliance requirements. These steps and the required computer systems and computer implemented business processes can be time consuming and costly. Also, they can be an obstacle to concluding transactions on a timely basis.

Furthermore, the personnel involved in negotiating various elements of such transactions are often on the move. In order to meet the various requirements mentioned above, however, it is often necessary to maintain an administrative office for administering the various required steps, and also for example to store documents or enter documents to document management systems and the like. The costs associated with such administrative office can represent significant overhead. Also, significant resources can be involved in travelling to the administrative office to return required documents. Especially in industry segments where they may be significant time pressures, such as for example in the case of competitive bidding for the purchase of a house, or with multiple providers competing for the business of a client, the prior art solutions can be problematic, and ensuring that the administrative infrastructure is sufficient to attend to tasks quickly can be very costly indeed.

In numerous industries, transactions may be often guided by a set of underlying business logic that determines, and/or triggers certain events or actions. The business logic may, for example, vary the workflow involved in completing documents and agreements depending on the type of transaction, the presence/absence of certain provisions, clauses, agreements and/or conditions, among others. For example, certain sections of certain documents may have to be filled out, certain additional documents may have to be generated and agreed to, certain declarations may have to be made, and so on.

As a non-limiting, illustrative example, in the context of a real estate transaction, transactions utilize a set of standardized agreements, and these standardized agreements may have different business logic depending on whether a deposit is required; the irrevocability of an offer; whether the closing date is the same as the date of the agreement; whether chattels/fixtures are to be included; whether the property is jointly owned or owned by more than one individual; whether the owner of the property is married; the presence/absence of security interests, liens, covenants or easements; whether a title search is necessary; whether a home inspection is necessary, whether a status certificate is necessary; whether taxes need to be paid; the presence/absence of outstanding property taxes or maintenance costs; the particular zoning of the property or required re-zoning; whether a closing is conducted electronically; whether a mortgage is attached to the property; the presence/absence of insurance issues; any adjustments required; any property assessments required; objects requiring tendering; whether there are any issues with environmental laws; among others.

In some transactions, especially complex transactions, the business logic may be difficult or cumbersome to follow. Incorrectly applied business logic may then lead to inaccurate or missing documentation, which may then cause significant challenges during or following the transaction.

Further, the existing process of obtaining signatures, signing documents, and their associated workflows may work well with paper-based solutions, but may be cumbersome and/or problematic when using mobile computing platforms. For example, a paper document may be distributed to people in a physical room for each to individual review and provide their signatures. In this traditional paper-based setting, the verification of identities and ease of distribution is relatively simple. However, in a mobile computing based solution, there may be additional issues with security, verification, and also further opportunities to streamline or improve the process through leveraging the advantages of using mobile computing solutions.

Enterprises and workers alike are interested in exploiting the advantages of using mobile computing solutions, however, prior art solutions do not generally enable multi-party transactions using mobile devices alone, if this is desired by the participating users.

The problems identified above lead to lost productivity, increased downtime, reduced efficiencies and low competitiveness.

There is a need for a transaction platform that allows multiple users, using their mobile device, to interact with one another to negotiate transaction documents, sign documents and conclude transactions efficiently.

### SUMMARY

In one aspect, a computer system for managing one or more workflow associated with negotiating and concluding transaction documents is provided comprising: a system for managing one or more workflow associated with negotiating and concluding transaction documents comprising: (a) a plurality of computer terminals linked to a computer network, including computer terminals that are mobile devices, each computer terminal associated with an individual; and (b) one or more computers executing a computerized transaction workflow management system that provides a computer network that when executed enables: (i) interaction of users with transaction documents based on their permissions, based on their role in a transaction; (ii) negotiation of transaction documents between parties to the transaction by enforcing a series of negotiation rules associated with the transaction, while allowing the parties to view and sign transaction documents related to the transaction securely using the computer service; and (iii) tracking actions in relation to the negotiation and conclusion of transaction documents for the purposes of automatically generating information regarding the current status of negotiation and optionally also to generate audit information.

In another aspect, one or more transaction documents (and associated information) are linked to a particular transaction, the transaction is associated with negotiation rules, and the computer service includes one or more utilities for generating transaction documents, viewing transaction documents, annotating transaction documents, distributing transaction documents, and signing transaction documents, in each case depending on specific rights of a user accessing the computer service based on the negotiation rules.

In some aspects, a method for managing transaction documents is provided. The method includes: generating or accessing, at at least one processor, a transaction data set including a plurality of clauses in a transaction document, the transaction data set associated with at least one transaction rule for managing workflow based at least in part on a type of the transaction document; receiving, via a device or account associated with a first party of the transaction, an input to modify at least one of the plurality of clauses; and based on the at least one transaction rule, generating signals to notify a device or account associated with a second party of the transaction who is required to accept at least one aspect of each of the modified clauses.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1a is a system diagram of the system of the present invention, in one implementation thereof;

FIG. 1b is another system diagram illustrating the present invention, in another implementation thereof;

FIGS. 2a, 2b, 2c, and 2d show certain aspects of a possible implementation of the home screen of the present invention;

FIGS. 3a, 3b, 3c, 3d, and 3e, illustrate possible functions of the system of the present invention for interacting with transaction documents;

FIGS. 4a, 4b, 4c, and 4d illustrate further aspects of completing transaction documents using the platform;

FIG. 4e illustrates possible functions of the system of the present invention for interacting with transaction documents, wherein the stack provides links to each page of one or more documents;

FIGS. 5a and 5b show representative screens illustrating the document signature functions of the present invention;

FIGS. 6a and 6b show representative screens illustrating the negotiation tracking features of the present invention;

FIG. 7 shows a screen that illustrates possible information collected by the platform (10) for the purposes of authentication of a transaction and non-repudiation of a signatory;

FIG. 8a shows a possible notification pop up menu;

FIG. 8b shows a screen that illustrates a possible mechanism for presenting draft transaction documents to a client for review and signature;

FIG. 9 shows a screen that illustrates a vendor list presented by the system of the present invention;

FIG. 10 shows a sample illustration of information being provided by the system to external systems, according to some embodiments of the invention;

FIG. 11 provides a screenshot illustrating an example progress bar, according to some embodiments of the invention;

FIG. 12 provides a sample flow illustration for a local signing process, according to some embodiments of the invention;

FIG. 13 provides a screenshot illustrating an example comparison of a plurality of signatures for two individuals, according to some embodiments of the invention;

FIG. 14 provides a screenshot of the graphical user interface providing information related to a signature, according to some embodiments of the invention;

FIG. 15 shows a generic computer system for executing the functions and features of the present invention.

FIG. 16 shows a flow chart illustrated aspects of an example method according to some embodiments of the invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

In one aspect a multi-user transaction platform is provided that enables multiple users to connect to a computer network service (“platform”) (10) that manages one or more workflows relevant to concluding a transaction as between the multiple users, or a sub-set of such users (“transaction workflow”). In one aspect, the platform provides a transaction solution that enables users to connect to a digital document workflow key aspects of a paper based transaction workflow, using a variety of different network-connected devices such as desktop computer or laptop computers but also smart phones and tablet computers.

The multiple users participating in the transaction workflow, or their representatives (“participating users”) may access the platform using a mobile device (12). The mobile device (12) may be any manner of mobile computing device such as a tablet computer or a smart phone. Participating users may also connect to the platform using for example a desktop computer or a tablet computer. In fact, to view certain documents, many participating users may receive a notification for example at a smart phone and then switch to a tablet computer for example to view documents better, or if they determine that they want to annotate a document. Various other workflows are possible that may involve users determining, based on their preferences or conditions at the time, that they want to switch from one device to another. The platform is designed to provide flexibility to support such different workflows, while enforcing negotiation rules and other standards that may be important for processing transactions online, as referenced herein.

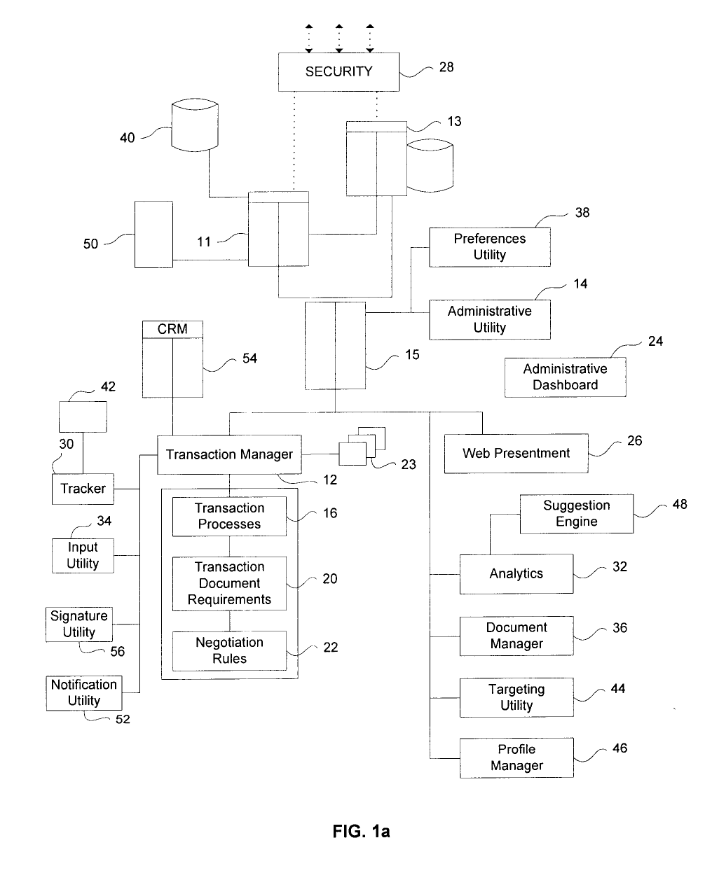

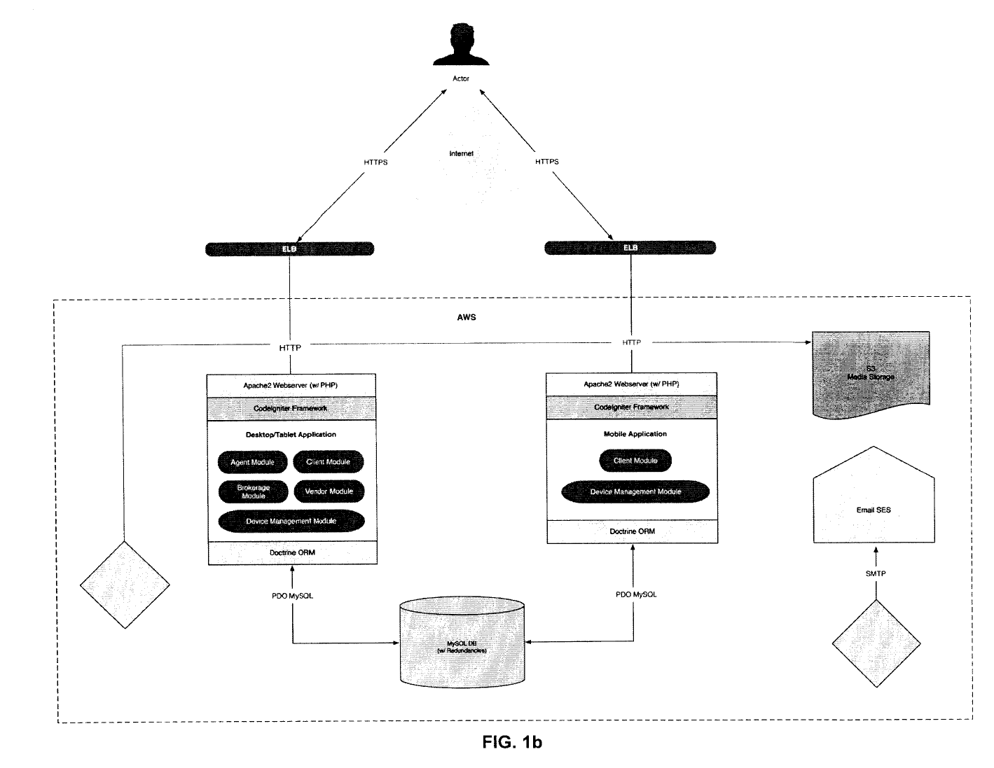

FIG. 1a illustrates a representative computer system implementation of the present invention.

In one aspect, the transaction workflow may ordinarily require: (a) completion of multiple transaction documents with required information, in an accurate manner; and (b) signatures from one or more of the participating users, in some cases different signatures of different participating users on different transaction documents. The completion of multiple transaction documents in an accurate manner, and also the collection of required signatures can be time consuming. Furthermore, the transaction flow may involve specific rules related to the progress of the transaction from initiation, completion of intermediate steps, possible interactions between participating users such as offer/counter-offer(s)/acceptance, and ultimately completion of all steps required for conclusion of the transaction. Tracking the current state of completion of the transaction and also can be complicated and time consuming.

The specific rules for the transaction flow may further include the development and application of one or more sets of rules related to application of the underlying business logic in a transaction. Depending on factors such as the state of the transaction, the presence/absence of various triggering events/conditions, and so on, the transaction workflow may require the completion of various different sections of various documents. As a simple, non-limiting illustrative example, if the system has an indication that the seller is married, the transaction workflow may require input from his/her spouse or a declaration made by the seller. Further examples where business logic may be required include, but are not limited to, the sale of a condominium as opposed to a house, the presence of security interests, the presence/size of a required mortgage/financing, etc.

Additionally, once certain actions are completed (such as actions related to a transaction document) the requirement for additional actions may also be triggered. These actions may be internal or external to the platform. For example, the execution of an offer requiring an inspection may trigger a reminder to engage an inspector, or in fact one or more aspects of engaging an inspector may be automated. Similarly, in an insurance application of the technology, a request for insurance or submission of an insured profile may require the review and attention of an underwriter prior to an offer being prepared and submitted to a client. Also, various transaction documents may require one or more approvals. Further examples are provided below.

Prior art solutions generally require participating users to use for example project management programs or reminder systems that, in the prior art, operate generally separate and apart from the transaction documents themselves, and also generally require time consuming data entry in order to assist in tracking actions required of the various participating users. The real estate example in operation described below explains some of the challenges in keeping track of the progress of negotiation/conclusion of various transaction documents. Furthermore, in many environments processing of transactions involves faxing back and forth of signed documents, including in some cases addition of additional terms in order to modify an offer for example.

Furthermore, once the items requiring negotiation in connection with a transaction have been completed (which may vary depending on the transaction), based on prior art solutions the various transaction documents generally still need to be prepared. Even with document creation tools that reduce duplication this can be time consuming.

In one aspect, the platform includes a transaction manager (12). The transaction manager (12) includes or links to an administrative utility (14) that allows one or more administrative users to set up one or more transaction processes (16) related to the transaction flow. These may include for example: (a) required transaction document(s) (18); (b) required information to complete each transaction document, including information regarding parties to a transaction document, information concerning the transaction, and signature requirements (“transaction document requirements”) (20); and (c) one or more transaction document negotiation rules (22) relevant to negotiating transaction documents such as the parameters of making offers and counter-offers, approval requirements (approval by whom at what point, with what evidence of approval and so on).

The transaction manager (12) may include or link to a series of templates (23) that contain for example typical transaction processes for an industry or business segment for example “real estate”, “insurance” or “banking”. There may be templates (23) related to sub-categories such as “home insurance” or “insurance for X type of business” and so on. Templates (23) may provide a starting point for enabling administrative users using a suitable administrative dashboard (24) for example to select particular transaction processes, modify the parameters of transaction processes, or create new transaction processes using for example functionality similar to a rules builder used in various technology platforms.

The templates (23) may further contain functionality that is based upon the application of a set of rules that are related to the underlying business logic of a transaction. For example, if the template is for “real estate”, the template may also contain rules that support the underlying business logic for a “real estate” transaction.

The set of rules related to the underlying business logic of a transaction may be developed such that the application of the set of rules allows the platform (10) to guide a user throughout the process, for example, indicating which fields need to be filled out on which documents, identifying that a field has been filled out incorrectly based upon prior information provided, automatically filling out certain fields based upon pre-existing data, etc.

Each particular template (23) may be pre-populated with a set of rules that are related to the underlying business logic of the transaction contemplated by the template (23), and any modifications to the parameters of the transaction processes.

Templates (23) may be stored to a database (40). The platform (10) may include a web presentment utility (26) that cooperates with the administrative utility (14) to present a series of web areas or web pages, based on permissions associated with a platform client and their various users, or individual users themselves. The platform (10) includes a security layer (28) that ensures that users access only their information (or the information of their organization), and that the web presentment utility (26) presents only web pages (and processes embodied by those web pages) that have been set up for such users. Templates (23) for example may be proprietary to a particular platform client and the security layer (28) is implemented to restrict access to templates or to client data authorized users only. Further details regarding security are provided below.

In one aspect, a set of transaction parameters and related transaction documents may be embodied in the templates (23). Templates (23) may relate to a particular transaction, or a set of transactions related to a particular vertical, industry, or business segment. In one aspect, such a template may collect a set of transaction documents and related transaction processes that drive a particular transaction or set of transactions.

Different platform clients of the platform (10) may iteratively configure, manage, and update their various transaction processes, and also define a set of rules for triggering particular templates or transaction processes depending on parameters, such as for example capture and analysis of a set of data elements identifying the nature and scope of a transaction. Various embodiments of the administrative utility (14) and associated administrative dashboard (24) are possible.

The transaction processes (16) may embody a series of rules for completing transactions efficiently and providing related functionality such as the offers discussed below. The examples in operation provided below further illustrate the types of transaction processes (16) implemented to the transaction manager (12).

The transaction processes (16) may further embody a set of rules that are related to the underlying business logic of the transaction. The set of rules related to the underlying business logic of the transaction may provide functionality to help guide the user throughout the transaction, such guiding potentially including identifying the next field to fill out, identifying incorrectly filled out fields, pre-populating certain information, preparing additional documents that will be required for completion, etc. As an illustrative, non-limiting example, where a deposit is required for a specific type of transaction, the underlying logic guiding a particular user with a particular role may indicate that the user has to sign in a particular location for a particular purpose; another individual with another role may have to execute a particular task, etc. The transaction manager (12) may be configured to implement the set of rules embodying this business logic, which may help ensure that steps are initiated in proper sequences, and requested from the right individual. The set of rules may be designed, based on the underlying business logic, to provide the individuals/users with instructions on what fields to fill out, fields may be pre-populated, documents may be prepared, and so on. The particular set of rules may be further designed to incorporate the negotiations process, providing guidance and streamlining to users on different sides of a transaction. For example, if a user wishes to indicate that a certain chattel is now included, a counterparty user may be notified that such a chattel is now included and to review the latest purchase price.

The transaction manager (12) may define a series of transaction steps or stages, which may be associated with the parameters. Transaction steps or stages may be used for enabling participating users to know the current status of a transaction, driving the tracker utility (30) discussed below, and triggering notifications or alerts that promote completion of transactions on an efficient basis.

The transaction manager (12) may include various features or functions that are often made part of a workflow manager, including for example recommendation features that recommend next steps in a workflow to users, logging of transaction steps and related information in order to enable application of analytical operations and reporting on the results, for example to a manager. The transaction manager (12) may be linked to an analytics utility (32) for this purpose. Various intelligent features may be supported by the analytics utility (32), and some examples are provided below.

Signature requirements may include the entities who are required to sign a transaction document, based for example on their role in a transaction, and also the required formalities pertaining to their signature such as level of authentication required, type of electronic signature required, in some cases ink or digital ink signature required, witnessing of signature that may be required using electronic or non-electronic means.

In one aspect of the invention, the transaction manager (12) is linked to an input utility (34) and to the web presentment utility (26) in order to present one or more screens enabling the participating user to provide relevant information, or to import relevant information from other databases. In one aspect, the input utility (34) is triggered by a user accessing one or more transaction documents that have open requirements, such as required information that is not yet accessible or has not yet been supplied. In one aspect, a participating user only needs to provide the same information once. In one aspect, a transaction profile is associated with each transaction document (18), and each transaction profile includes a plurality of fields, including fields requiring specific information. Fields across different transaction documents (18) that require the same information are associated with one another. The input utility (34) populates available information into the transaction documents (18) displayed by the platform, as particularized below. The input utility (34) therefore reduces duplication, but the platform also ensures that each transaction document (18) is a unique data entity which supports transaction or document authentication as explained below.

In one aspect, the input utility (34) is linked to the transaction manager (12) in order to automatically present selected screens for initiating users to input selected information based on the current state of the system in relation to a particular transaction process (16). This allows the input information to be intuitive using context of the relevant transaction process (16).

In one aspect, the input utility (34) may provide additional functionality to users through the application of a set of rules that support the automatic identification of various acronyms and/or shorthand. The input utility (34), in this case, may be able to receive text inputs, data inputs, emails or similar input means, parse them and provide input based upon, or expanding upon, the information provided. Implementations may include, but are not limited to, the use of automated email parsers, designated emails, designed phone numbers, automated text/SMS/iMessage parsing services. These implementations may identify and apply business logic depending upon where a message is received from, what time the message is received, from whom or from what device a message is received from, at what stage in the process a transaction is in, etc. Further, the identifications may also respond with messages acknowledging receipt, indicating parsing/translation issues and/or ambiguities, indicating errors, requesting corrections, etc. (e.g. if there are errors detected—the system may return: “You indicated John Honcock. Do you mean client John Hancock?”)

Input fields may be shortened using acronyms that the user configure in a separate interface, or may be pre-set into the system as shortcuts. For example, each input field may be represented by two/three capital letters followed by a dash. In this example, a user may be able to text the following: OFF-Condo Purchase, PP-550, CL-John Hancock, MLS-9383020, etc. In this example, “OFF” may indicate “offer”, “CL” may indicate client, “PP” may indicate purchase price, “MLS” may indicate multiple listing service identification number, etc. The input utility (34) may be able to configurably customize a set of acronyms that may be parsed as the system as variables, and users may be able to create their own acronyms for use through the system.

The input utility (34) may further be able to access the database storage server (13) to pre-populate data or provide information to match and/or parse data received.

A messaging application may also streamline the document generation process, which provides auto-populated forms, where a user would be able to select the relevant portions of a form and/or enter the relevant data. An iterative process may be provided wherein the system may interpret information, prepopulating several documents where a user may then provide corrections or fill in missing information.

The use of this functionality of the input utility (34) may trigger the provisioning and development of transaction workflows and documents, even without the user directly accessing the interface. For example, a realtor would be able to initiate an offer process simply by sending a text message to the input utility (34). The input utility (34) may then parse this text message and understand that an offer has been initiated, with various information, if included in the text, pre-populated.

In another aspect, the platform (10) includes a document manager (36) that enables administrative users to import to the platform one or more transaction documents (18), as particularized below. In one aspect of the invention, in connection with many transactions, participating users are familiar with particular transaction documents (18). These transaction documents (18) are normally paper based documents. These transaction documents (18) may be developed and required for example by a regulatory body or in the case of real estate, by a real estate board for example. One contribution of the present invention, is a unique and innovative way to provide an electronic transaction platform that integrates paper based transaction documents (18) that users are familiar with, and that also may meet legal or regulatory requirements.

One objective of the use of transaction documents (18) in accordance with the present invention is ease of adoption of the platform. The entities involved in numerous transactions are used to operating based on particular transaction documents (18), which may even be mandated in their jurisdiction. These transaction documents may exist (prior to deployment to this platform) in paper form only, in which case shifting users to an electronic workflow is promoted if a platform can be designed that incorporates transaction documents (18) in some way that minimizes change, and the disruption, learning or training that may be associated with change. In some cases, sometimes depending on the jurisdiction, electronic documents may exist. In most cases, whether paper documents or electronic documents are used, the back and forth involved in negotiation of the transaction usually includes entities involved reviewing particular documents or forms with which they are familiar.

Each participating user may be provided with their own area by the platform (10), and the resources associated with the area may be defined in part by their roles. For example the area linked to a real estate agent will be different from that of a seller or buyer. The participating user may use features of a preferences utility (38) to define their preferences. An area may allow a participating user to upload to the platform for example preferred precedents for example precedent clauses for a transaction document (18). These clauses may be stored using the document manager (36), and in one aspect the platform may automatically integrate clauses into certain transaction documents (18) generated by the associated participating user.

### Trust and Enforcement of Negotiation Rules

In one aspect of the invention, the platform (10) is designed such that the negotiation rules are enforced by operation of the computer system. This is important in order to ensure that the platform (10) replicates the trust that is generally built into paper based transactions processes.

In one aspect, the transaction manager (12) logs each action relevant to a transaction to a persistent data store, which may be provided by database (40). Along with logging each action, the platform (10) also logs the identity of the participating user, linked to the corresponding action. The transaction manager (12) applies the relevant transaction parameters to each action, to create a log file for each action. The log files are used to track for example offers or counter-offers. The logging of each action, as described, in a persistent manner to the platform (10) establishes trust, and by mean of this trust provides a computer network environment in which validated transactions are concluded. Participating users may not alter actions once they have been logged, pursuant to the transaction parameters.

The platform also establishes trust by enforcing document version control. In one implementation, this aspect is implemented as part of the document manager (36). This means that every change to a transaction document is recorded in a persistent manner. Also, the security layer (28) prevents unauthorized access to the platform (10). These features allow implementation of adherence to the negotiation rules (22) and therefore replicates the trust that is normally established in paper based transaction workflows using costly steps and infrastructure.

In another possible implementation of the invention, transaction documents (18) are implemented as file upload forms, which may be XSS filtered (cross site scripting) and validated by the server computer (11) to ensure validity of information stored to the database (40).

In another aspect, requests for sending signatures to the server computer (11) are verified for XSS, and security tokens are verified against each user. In another possible aspect, the images representing particular transaction documents (18) may be stored on a separate data storage server (13) for storing transaction documents, in order to provide an added security measure. In another possible aspect of implementation of the invention, the application server (15) may be required to provide additional security keys for every request made for communication with the data storage server (13).

### Notification Service

In one aspect of the invention the platform (10) includes a notification service or notification utility (52) that notifies the other participating users when another participating user has engaged in an action relevant to a transaction. The notification service may be linked to the transaction manager (12) such that the transaction manager (12) automatically sends reminders to participating users to engage in required action(s) for advancing a transaction.

In another aspect, when action is required by a participating user such as their providing a signature, or provision of information, in one implementation an email message (or other suitable communication) is sent to the participating user's mobile device. The message includes a link that opens up one or more web pages that provide information regarding the relevant transaction document, and an interface for enabling the participating user to sign the transaction document.

In one possible implementation, the notification utility (52) is triggered automatically if the transaction manager (12) determines that an event has occurred that requires notification. For example if an offer has been received that is relevant to a particular client, the platform (10) may automatically send a link by email to that client, which enables the client to preview the offer.

Other alternatives are possible. For example, an event may trigger for example a prompt to “notify a client”. The agent for example may provide the email address of the client, or may automatically trigger a customer relationship management (CRM) utility (54) or equivalent. The CRM (54) may for example present various contact details and options for the client and enable the agent to select the best way of notifying the client. In one aspect, the agent may select multiple modes of notification. These may include a text message, a voice mail, and so on, all generally directed at requesting the client to check their email to click on a link that will take them to relevant transaction document (18).

Other options are available. For example, the notification utility (52) may present options such as “Notify other agent”, “Export document pdf”, “Notify client” and so on.

### Signature Utility

In one aspect of the present invention, the platform (10) may include a variety of tools or mechanisms for collecting and recording signatures required to support conclusion of a transaction and/or to provide non-repudiation for that transaction.

The platform (10) may integrate various technologies or processes for capturing and recording signatures in a signature utility (56).

In one possible implementation, the platform (10) is configured to deliver a link that allows a user to open a page that includes a signature page. The link may be delivered for example by the notification service (52) including in an email notification for example information related to the document that the user will be signing, and a link for signing the relevant transaction document (18).

In one possible embodiment of the invention, the signature utility (56) presents a view of the relevant transaction document (18), and optionally highlighting in some way the relevant portion that requires the particular user's signature, so that the user can review the document.

In some embodiments of the invention, the signature utility (56) may be configured to cause the platform to enter a “signature mode”, wherein the signature utility (56) may cause the highlighting of areas required for signatures and initials specific to one or more collaborators.

Collaborators may further be identified by their roles (e.g. buyer, seller, spouse, agent etc.), and the platform may be further configured to manages signatures throughout the agreement specific to that role, which may potentially be advantageous in limiting human error.

The signature utility (56), in one possible embodiment, is configured to collect a signature in a signature window (where a signature can be made using any suitable input means such as a stylus, finger signature mechanism on a touch screen, a mouse or the like). In a possible implementation, the platform (10) stores the signature to the database (40) in a database record that is associated with a particular, time stamped transaction document (18).

Information relating to the signature may be stored in the database (40). The fields may vary and may contain additional fields comprising metadata that may be helpful in processing, verifying and tracking the signature.

The additional information may be an improvement over conventional paper-based signatures as it may be utilized to determine, for example, whether the individual signing the document signed at a particular location, using a particular device, whether the signature was conducted following a verification process, whether the signature has similar characteristics as prior signatures, the role of the individual, the identity of the individual (e.g. someone with a power of attorney), etc.

In another aspect the signature utility (56) may capture other information that identifies or helps identify the particular user, and their acceptance of a particular transaction document (18) at a particular time such as for example: (i) device type, (ii) browser version, (iii) IP address, (iv) user ID (usually email address), (v) date and time signed, (vi) verification of access token.

As a non-limiting illustrative example, signature variables may include: the signature image, signature type (e.g. cursive/keyboard), device type (e.g. desktop/laptop/Android™ phone/Android™ tablet/iPhone™/iPad™) browser (e.g. safari 536.26.16), platform (e.g. pc/mac), ip address (e.g. 99.232.148.107), user role (e.g. agent/buyer/seller/spouse), user email address, date & time (e.g. 2014-01-28 at 094834), security token (e.g. verified/unverified), pin (e.g. verified/unverified)

The signature utility (56) may automatically integrate the signature into the transaction document (16).

In another possible implementation, the signature utility (54) presents to each user a “current state” of the relevant transaction document (18) including as it relates to the signatures collected thus far. In one possible implementation, the presentation of the current state includes showing an image of the transaction document (18) that includes the signatures that have been provided thus far. In one possible implementation, the signatures captured as described above are stored to the database (40) and also linked with a particular transaction document (18). The transaction manager (12) may include functionality for stitching currently available signatures or other information to an image of transaction document (18) through an overlay such that when the current state of the transaction document (18) is shown to a user the signatures appear to the user to be in the spots that they would generally be located if the signatory or signatories had signed a paper version of the same transaction document (18).

In some embodiments of the invention, the transaction manager (12) may operate in conjunction with the signature utility (56) to manage the total number of signatures required to submit the offer, measuring executed signatures/initials against the total number of required signatures. The signature utility (56) may be further configured to cause the platform to provide a view of this progress, by providing, for example, a progress bar.

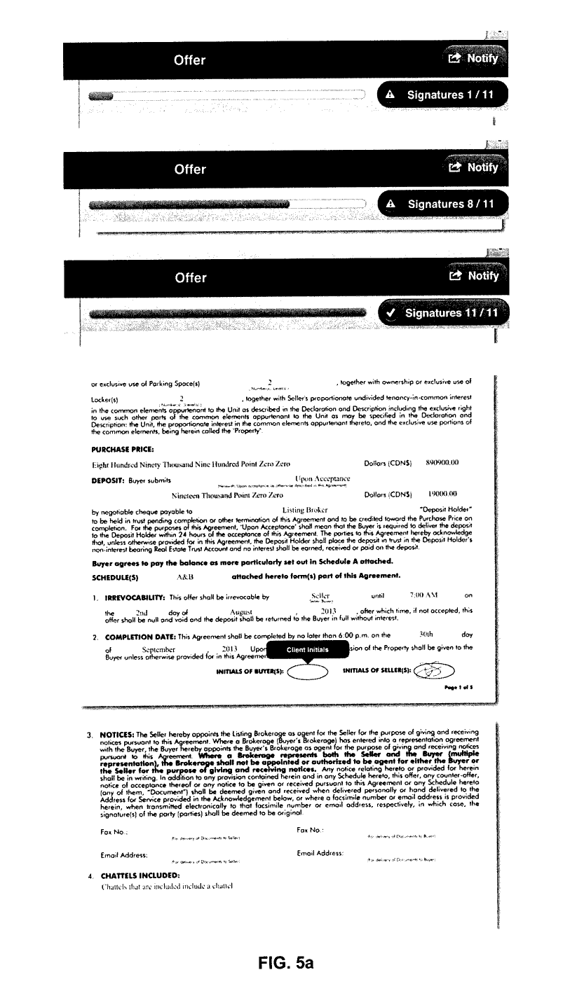

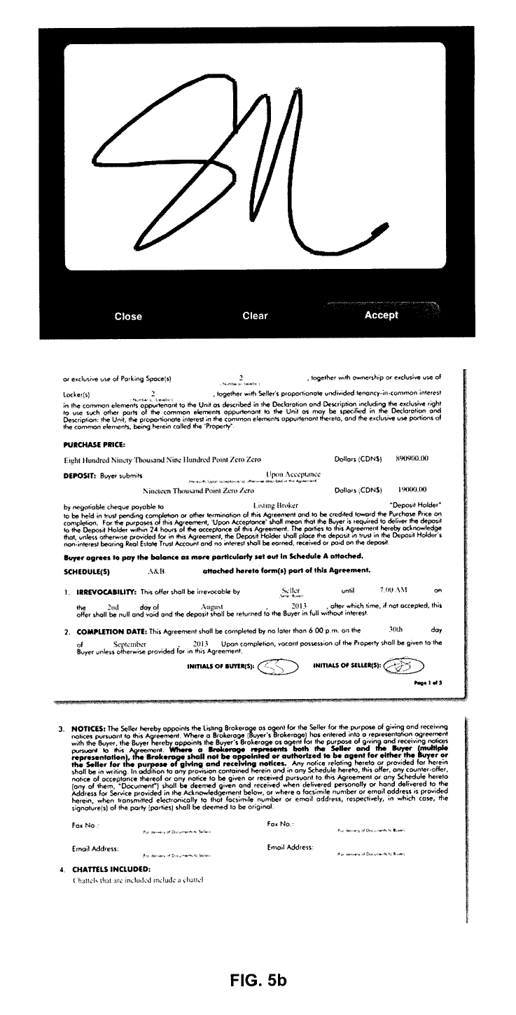

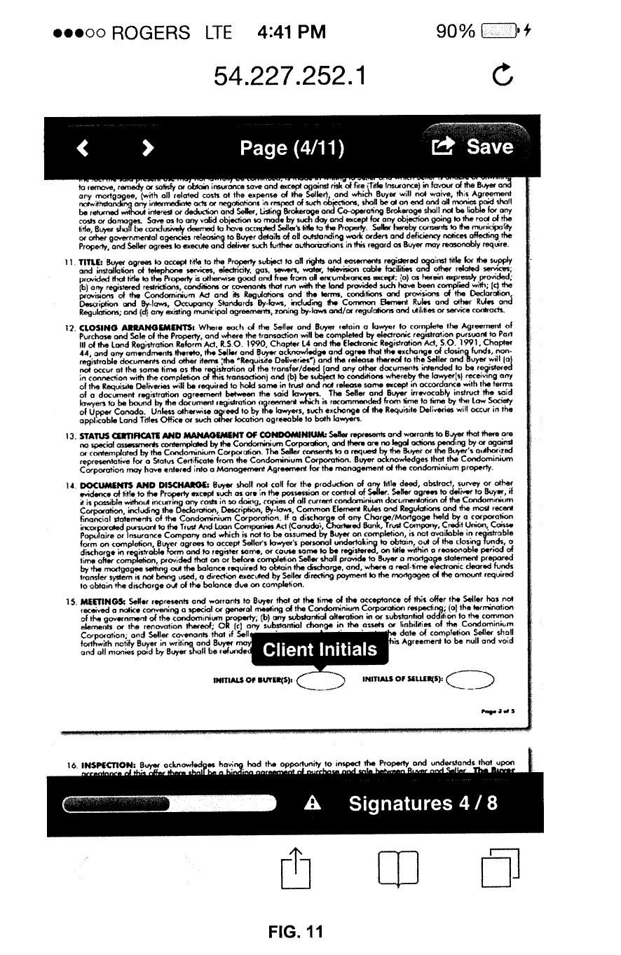

FIG. 11 provides a screenshot illustrating an example progress bar, according to some embodiments of the invention. In another possible aspect, implementation the signature utility (56) may include one or more features that guide a user to the particular areas of a transaction document (18) that require the signature of the user. In one possible workflow, the platform (10): checks the user's profile, determines based on their profile whether the user's signature is required. As shown for example in FIGS. 5 and 5b, the platform (10) may present suggestions and messages through the overlay that directs the attention of the user to particular portions of the image of the transaction document (18). For example a “CLIENT INITIALS” icon may be presented and may point to an area where initial are required. Or, “PLEASE CONFIRM YOU UNDERSTAND THAT . . . ” may point to a particular clause or provision in an insurance agreement.

In another possible implementation, these suggestions or messages may be platform generated. In another implementation, a user such as an agent or professional working on behalf of a client, can initiate an “ANNOTATE FOR CLIENT” mode or equivalent, which allows that user to annotate a transaction document (18) for a user. These annotations are presented along with the transaction document (18) by operation of the platform (10) but dynamically removed from other views.

In another aspect, once another signature is logged to the platform (10), the platform (10) checks the transaction document requirements (20), recalculates the degree of completeness for the particular transaction document (18), and if a request is made for a view of the transaction document (18) that includes a progress bar, an updated progress bar is presented that reflects the new signature that has been logged.

The preferences utility (38) may permit the configuration of settings regarding which users will be permitted to see degree of completeness information. For example, only internal users to an insurance company may see the various approvals that may be required and associated communications through the platform regarding a particular transaction document (18). This information may not be of interest to a client, the insurance company for example may not want the client to see this information, and further the associated business processes may be proprietary to the insurance company.

A similar workflow can be used by the platform (10) to direct the attention of a user to particular areas of the transaction document (18).

In some embodiments of the invention, the signature utility (56) may also be configured to remove initials and signatures related to a pages that has been changed or edited. In such an embodiment, the users may be required to sign the page again, in contrast with the traditional method of crossing out an initial or signature.

### Signature Utility—Remote Signing

In some embodiments of the invention, the signature utility (56) may further be configured to enable remote signing of documents located on another device and/or in the platform. This feature may be implemented by way of a remote signing PIN (which may for example, be implemented as a password and/or any suitable security device/technology, such as multi-factor authentication tokens, etc.)

The remote signing PIN may allow a collaborator to provide a signature after an account holder has shared the agreement with the collaborator.

One or more users may be defined as account holder, and the platform may restrict account holders to be registered realtors in good standing with their respective real estate boards. Account holders can give access to users whom they wish to collaborate with on the agreement on the platform. The collaborators may, for example, be buyers/sellers/spouses/agents/etc.

In an example embodiment, upon the initiation of the sharing of the agreement, a PIN may be generated by the system and communicated to the sender (e.g. through email, text, instant message). An email may also be sent to the collaborator with a unique link to the system. Upon accessing the link (e.g. opening the link in a browser) by the collaborator, the PIN may be required to access the agreement. As the PIN may also be received in the sender's inbox, the recipient may be required to retrieve the PIN for access to the agreement.

The retrieval of the PIN may be, in some embodiments, be conducted by an alternate communications means, such as in person or by telephone, and which may further allow the sender to verify the identity of the recipient prior to the initiation of their signing session.

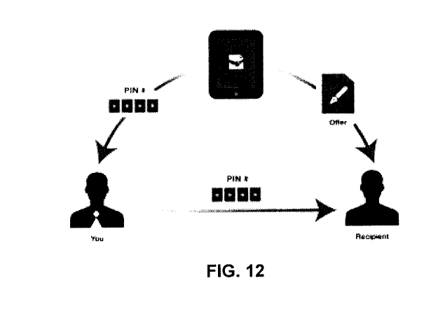

FIG. 12 provides a sample flow illustration for local signing, according to some embodiments of the invention.

Collaborators may be able to sign and resign any amount of times per signing session. For collaborators to be provided access to sign, the platform may require notification by the account holder or the cooperating agent collaborating on the agreement.

### Signature Utility—Local Signing

In some embodiments of the invention, the signature utility (56) may also be configured to provide account holders with the ability to have collaborators sign on the collaborator's own device, such as a tablet. Such an implementation may, for example, provide functionality that may mimic some of the characteristics of the paper process of signing.

This may be implemented in a variety of ways, and one such, non-limiting example for illustration is provided. The signature utility (56) may be configured, upon detecting that the account holder has attempted to sign on behalf of a collaborator, to send a PIN to the collaborators email. This PIN may in turn be required to be input on the account holder's device, and once the PIN is provided into the account holder's device, the collaborator's identity may be verified, and their signing session will be enabled on the account holder's device.

In some embodiments of the invention, the signature utility (56) may also provide functionality for the collaborator or the account holder to “log out” of a signing session and end the ability to sign documents with those credentials.

For example, a realtor account holder's device may be displaying an agreement with the account holder logged in. The realtor may be showing his/her device displaying a modified agreement to a buyer. Upon activating a buyer signature or initial area, to confirm that an electronic signature or initial will be inputted by the buyer (and not the realtor account holder), a PIN can be sent to buyer's device, email address or other avenue associated with the buyer. Once the correct PIN is entered, the realtor's device can be configured to allow the buyer to sign/initial the activated signature/initial area.

### Tracker Utility

In another aspect of the platform, the web presentment utility (26) displays a transaction step tracker that in one embodiment shows the back and forth involved in negotiating/conducting a transaction. This feature may be implemented as a tracker utility (30) that analyzes the various logged actions based on the transaction processes (16), including the negotiation rules (22) and determines iteratively the status of completion of a transaction or a set of transactions, with each action. The results of such analysis constitute a transaction “event” and these events may be stored in sequence. This tracking may include the signatures for particular documents mentioned earlier but other elements as well.

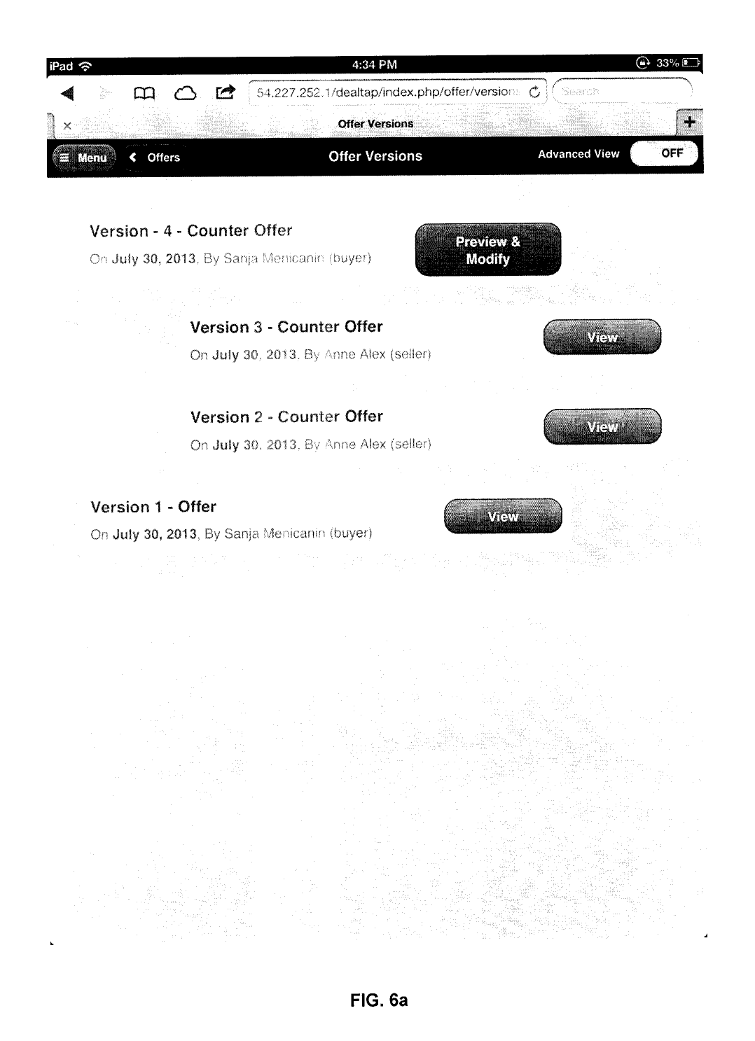

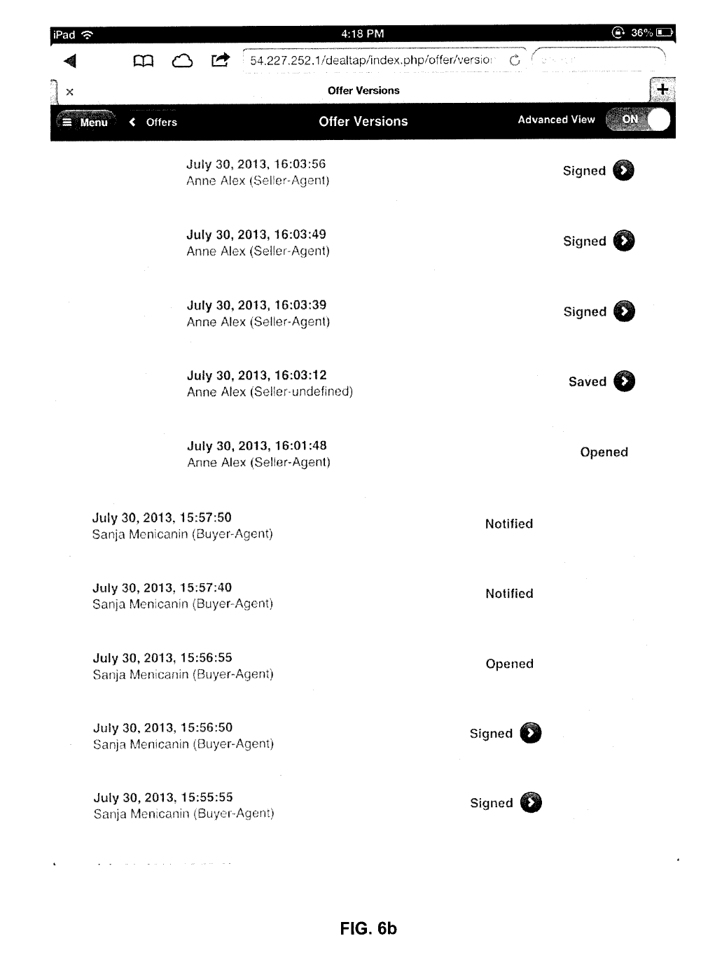

Certain parameters associated with each event such as the party initiating the action and, a summary of the action, may also be logged to the database (40). This results in a log of events which may be used for example to display the transaction log shown in FIG. 6b. For example in a real estate application, the tracker utility (30) keeps track of such negotiation steps as offers, counter-offers, or changes, and presents these in an easy to read user interface as described below. Additional related requirements such as approval may be tracked by the tracker utility (30).

In one particular embodiment, the tracker utility (30) is used in order to iteratively maintain an audit trail based on a series of rules. This is a useful feature in many applications where significant overhead is required in order to properly extract information from records, and log information to various processes or systems in order to maintain a proper audit trail. This is the case for example with insurance companies, as further described below.

In another aspect, the transaction manager (12) tracks the log files and calculates a degree of completion score for the transaction and/or for each transaction document (18). This functionality may be implemented as a transaction completion bar (42) or equivalent. In one aspect, the web presentment utility (26) displays a representation of the degree of completeness. In one implementation, this is provided by a slider, as shown in FIG. 5a for example.

In another possible aspect, as further discussed below, the tracker utility (30) may be linked to a progress bar which may be presented in one or more of the user interfaces of the platform (10). The tracker utility (30) may include a variety of parameters for defining the degree of completeness of a transaction document (18) and/or of an overall transaction. Various routines for determining completeness of a process or sub-process may be configured. Different progress bars may be presented by the platform (10) depending on context such as for example the particular transaction document being presented by the document viewer discussed later. For example, the progress bar may present a degree of completion based on a list of requirements associated with a transaction document (18) such as the number of signatures obtained in total relative to the total number of signatures required to conclude the document. Other parameters may be used such as approvals required, specific areas that a user has to confirm that they have read or understood, further actions such as provision of specific information required by an insurer or financial institution, or external actions such as ordering an inspection report. Various other parameters are possible.

As further explained below the progress bar itself may be designed and presented in a number of different ways. For example, additional menus may be associated with the progress bar that permit a user to view a list of outstanding items, and optionally a review of completed items. In one particular implementation, if a user clicks on the progress bar one or more such menus or lists are presented by the platform (10).

### User Interface

In one aspect, the platform (10) defines one or more transaction areas, each transaction area being association with a particular transaction or transaction set. The transaction area presents links to a set of relevant transaction documents.

In one aspect, the links provide access to images that are displayed by the platform (10), where each image corresponds to a page of the applicable transaction document (18). This allows participating users to view the transaction documents (18) that they are familiar with. This aspect may be implemented as a document viewer or document viewer pane.

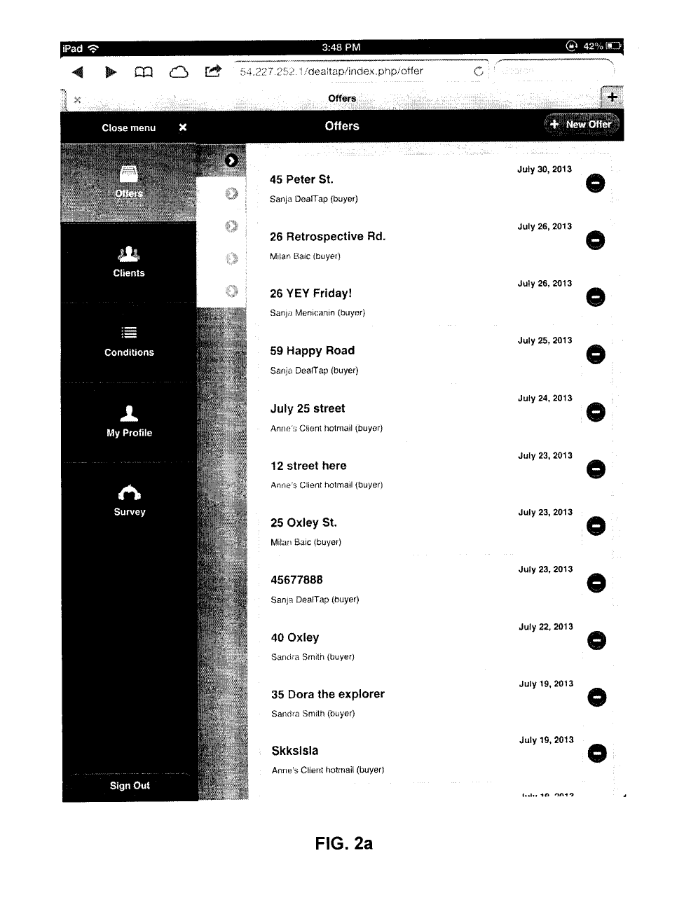

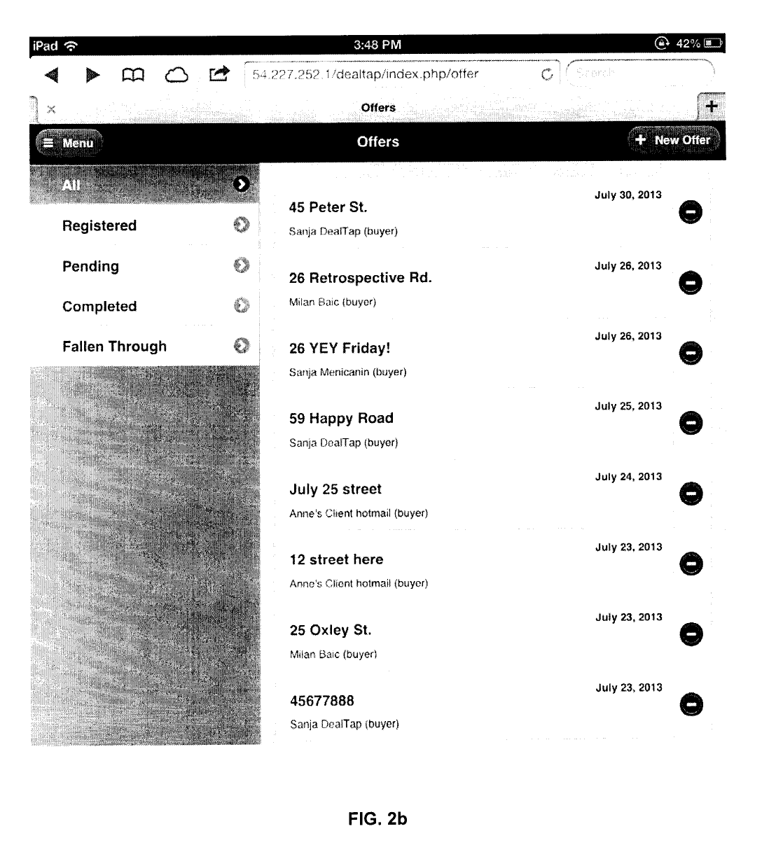

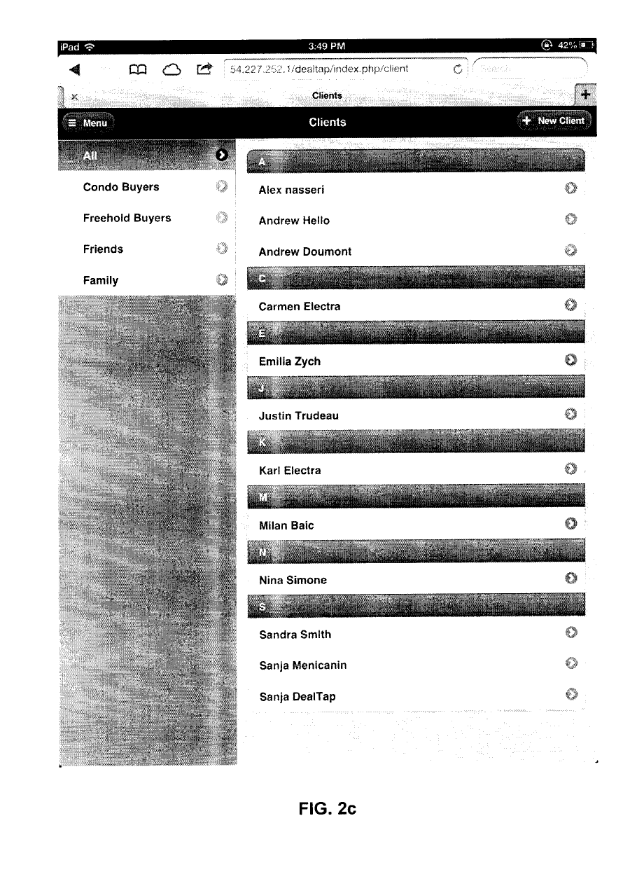

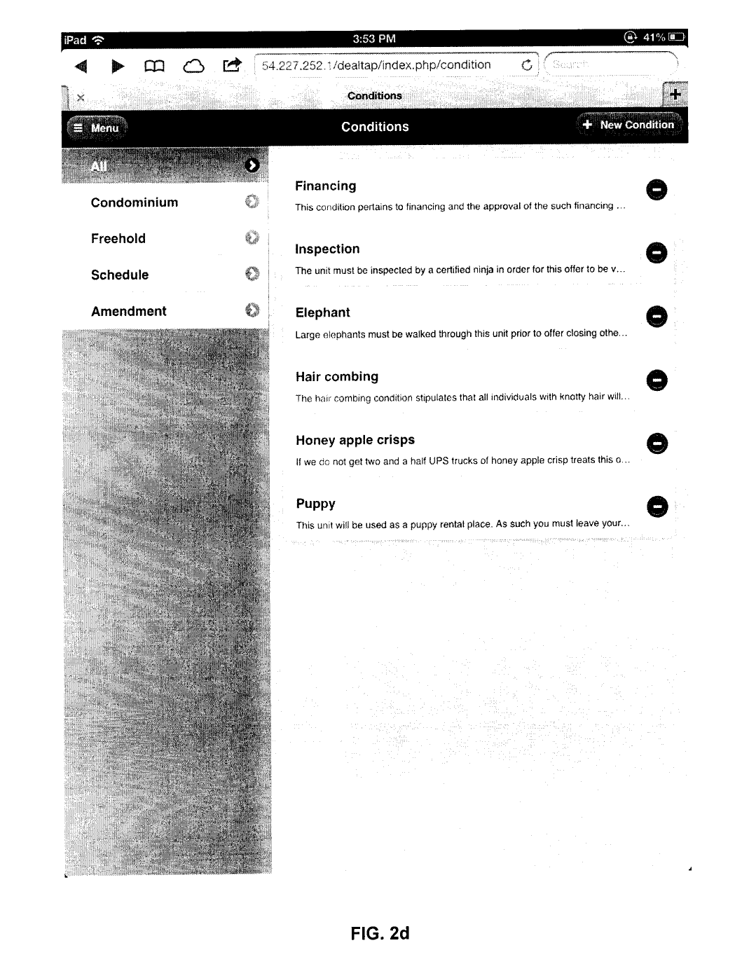

In one particular implementation, the web presentment utility (26) displays a home screen or menu. A representative view of such a home screen is shown in FIG. 2a. FIG. 2a illustrates a real estate example of implementation of the platform (10), and more particularly a home screen or menu presented to a real estate agent. The real estate agent can view their “OFFERS” for example in a document viewer, but also access information of their “CLIENTS”, “CONDITIONS” that they use, and also their profile information under “MY PROFILE”.

FIG. 2b illustrates a possible implementation of a more detailed screen for “OFFERS”. As stated elsewhere, the real estate agent may sort their offers based on number of criteria such as “REGISTERED”, “PENDING”, “COMPLETED” or “FALLEN THROUGH”.

FIG. 2c shows a possible screen for displaying client information, and accessing particular client profiles and making edits thereto.

FIG. 2d shows a possible screen for organizing, viewing, and adding specific conditions. These may relate to conditions preferred for example by an agent user for inclusion in various transaction documents (18), where it is permitted to provide customized conditions.

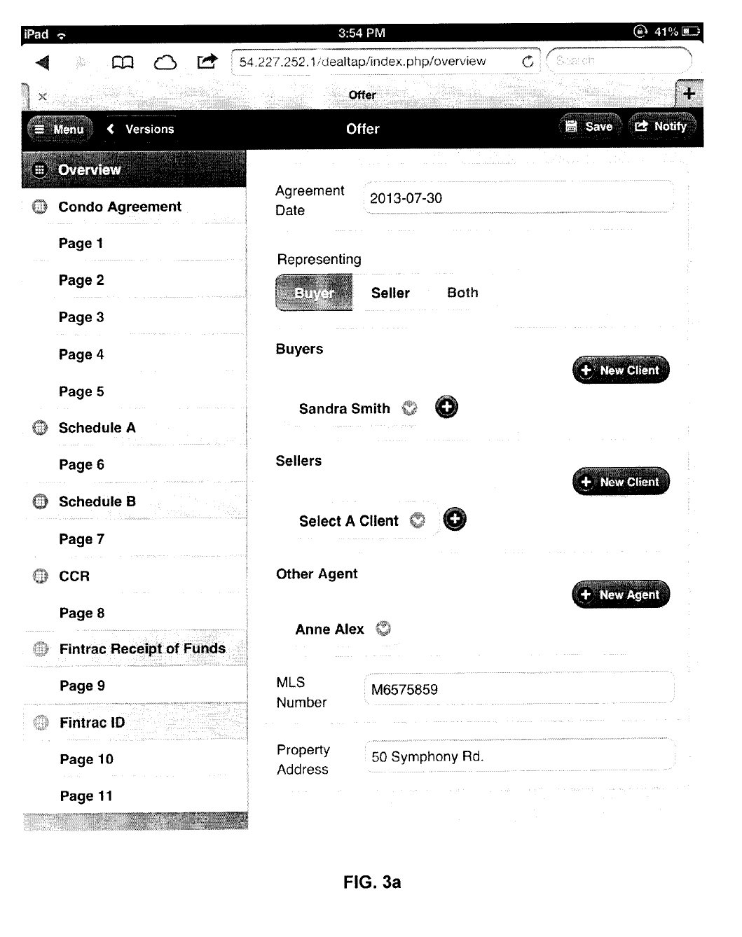

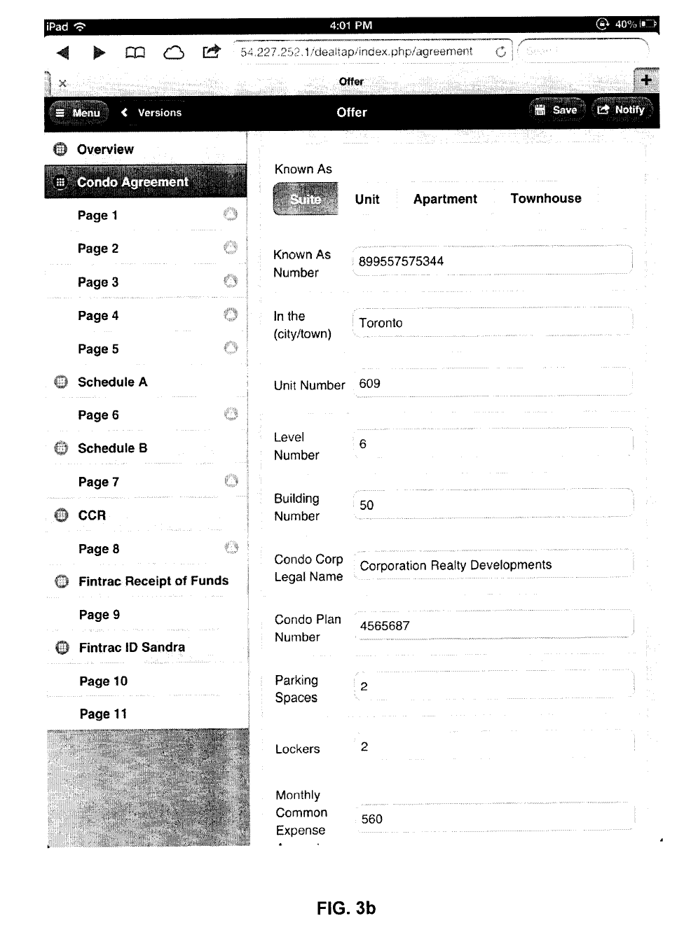

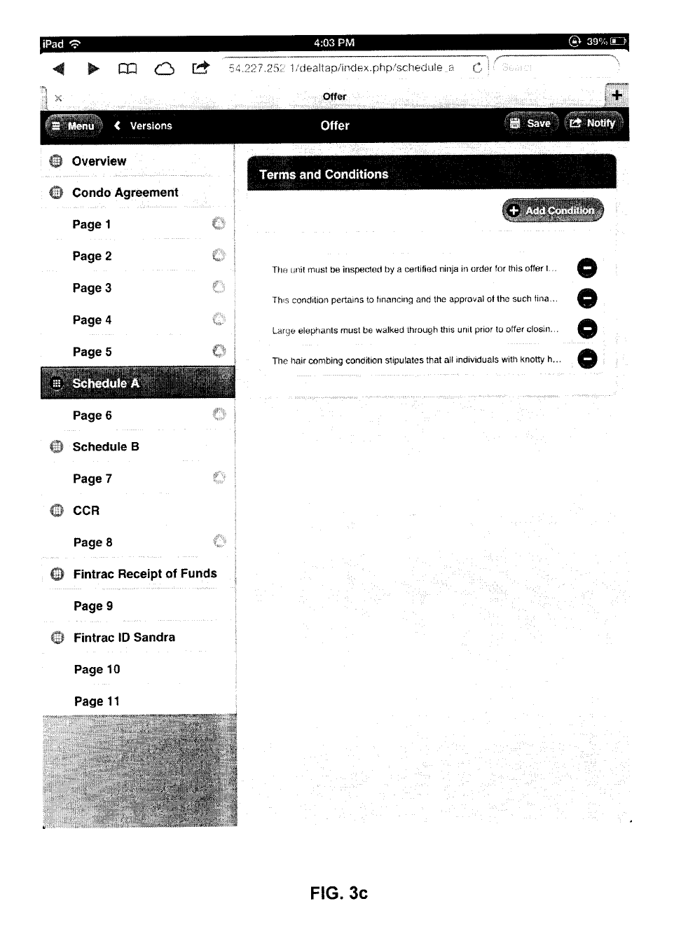

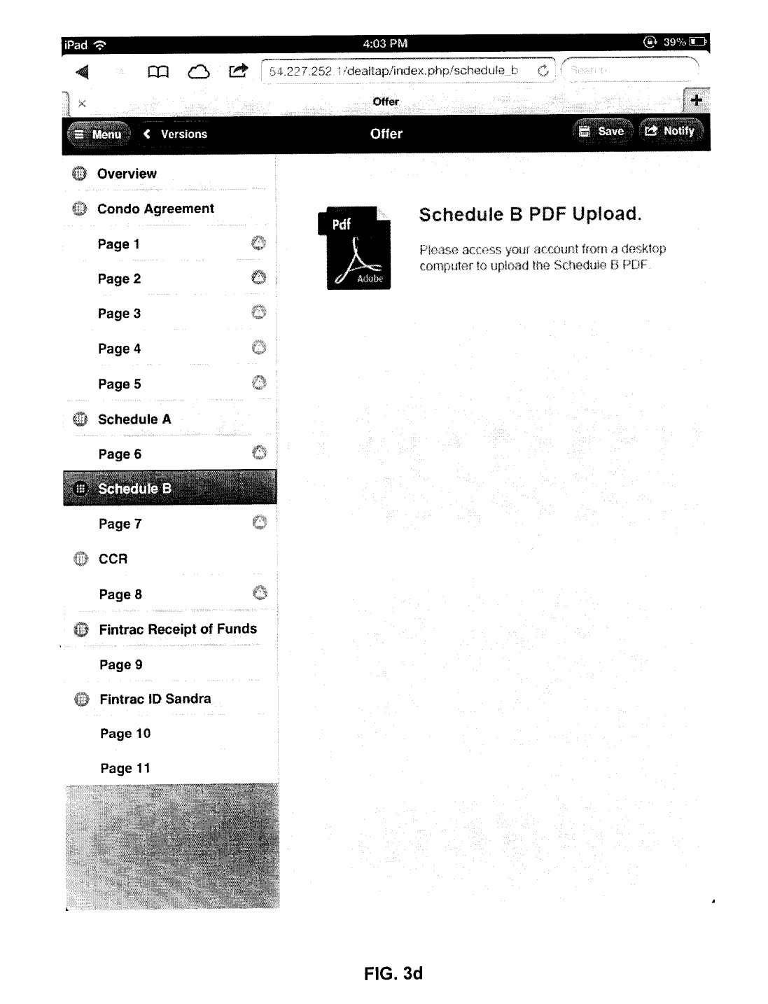

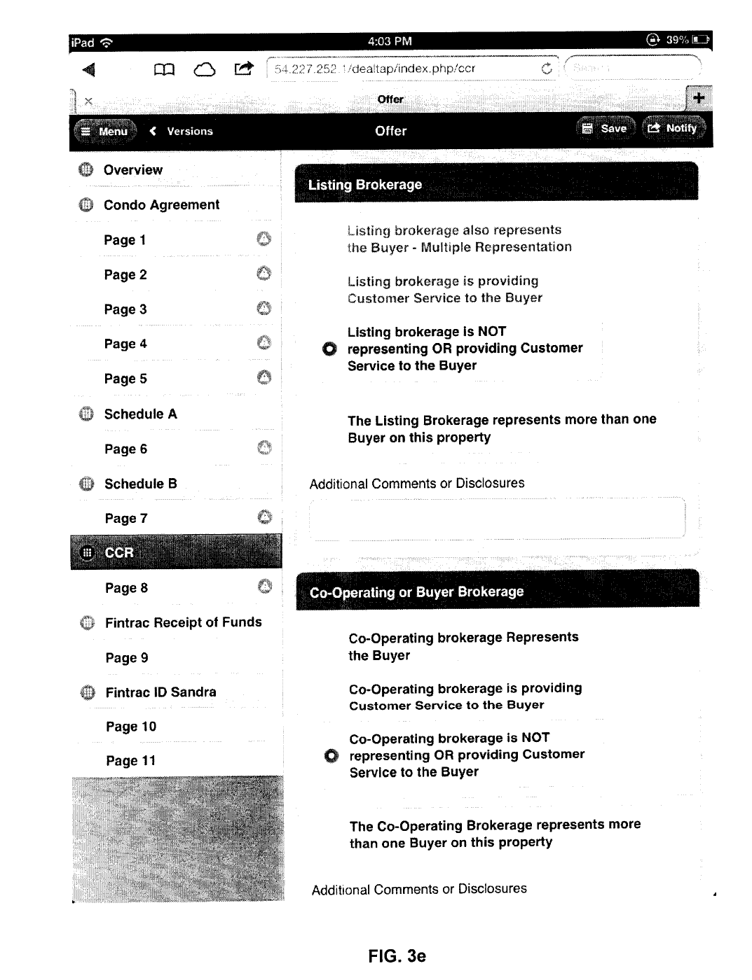

FIG. 3a shows a representative view of a screen used by a real estate agent to initially provide basic information related to a transaction document (18), in this example a real estate offer.

A “MENU” button or equivalent may be used to access various other features. A “SAVE” button uploads changes to the server computer (11) (and triggers the various version control aspects and negotiation rules (22) previously described).

Various parameters are provided by the user, or certain fields may trigger information to be imported by other applications such as the CRM (54). Once the agent is satisfied that the information is accurate, the agent selects “SAVE” which uploads the offer to the platform (10) (that is a set of code elements that define the parameters of the offer). This information is logged to the platform (10), and the platform (10) automatically applies the various transaction processes relevant to that particular transaction document (18)

In one possible implementation, the parameters set by the agent may include their selection of other professionals that they want to use for this particular offer, such as lawyers, appraisers, inspectors, mortgage brokers, banks and so on.

Selecting the “NOTIFY” button may automatically send notifications to all parties requiring notification based on the transaction processes (16) or selection by the agent, including for example the lawyers, appraisers, inspectors and so on.

In one aspect of the invention, one area (in this case shown on the left hand side) presents an overview of the plurality of transaction documents (18) required for a particular transaction. In this case these are shown by the highlighted areas in the stack. Each highlighted area is in effect a heading or title of a transaction document (18). Underneath the one or more pages for the heading or title indicated above are listed. The button for each page is a link that when clicked, automatically initiates a retrieval from the platform (10) of an image and associated data required to present a then current view of the relevant page.

The stack acts as a navigation interface to flip through pages of a transaction document (18) that may be required by legal or regulatory requirements, or may be consistent with the hereto paper based processes used by different user types. This particular approach for navigating between relevant pages of transaction documents (18) enables users to access conveniently the richer features of a digital platform, while so doing in a way that is consistent with the habitual paper based workflow. This particular design of the screens and associated workflows aids users in adopting the technology in a seamless manner.

FIGS. 3a, 3b, 3c, 3d, and 3e show that, in one possible implementation, when a user selects a transaction document heading, then certain related screens and their features and functions may be presented. Depending on the associated transaction processes (16), the user may be required to present more information, select particular conditions if there are several possible options, and so on.

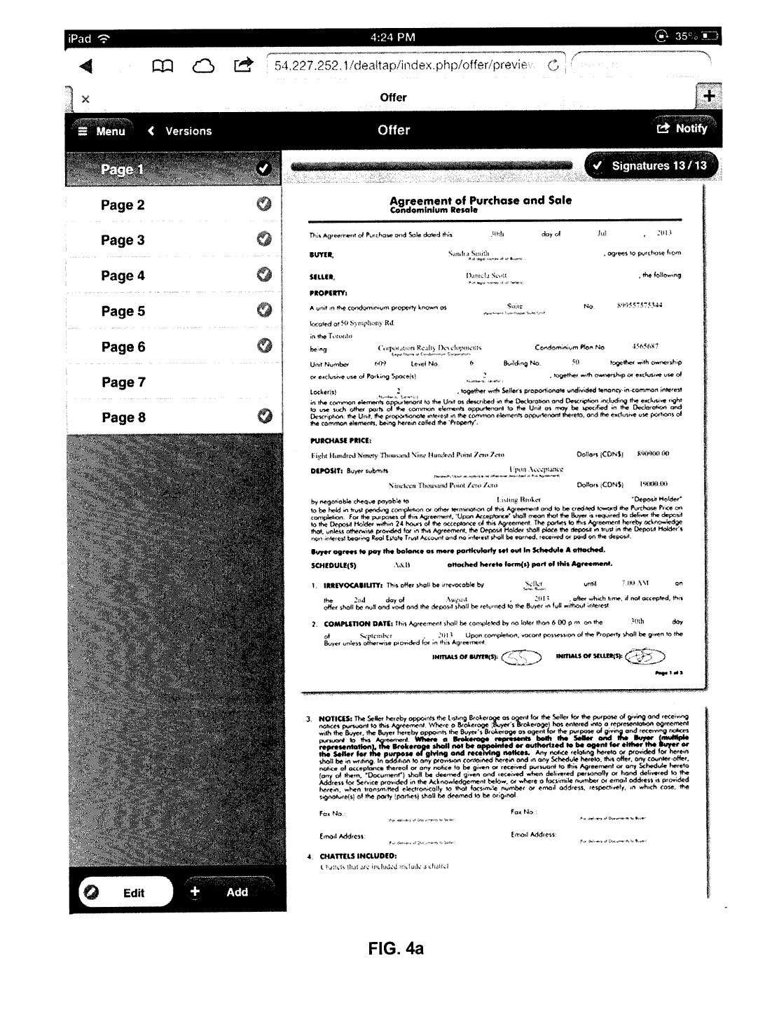

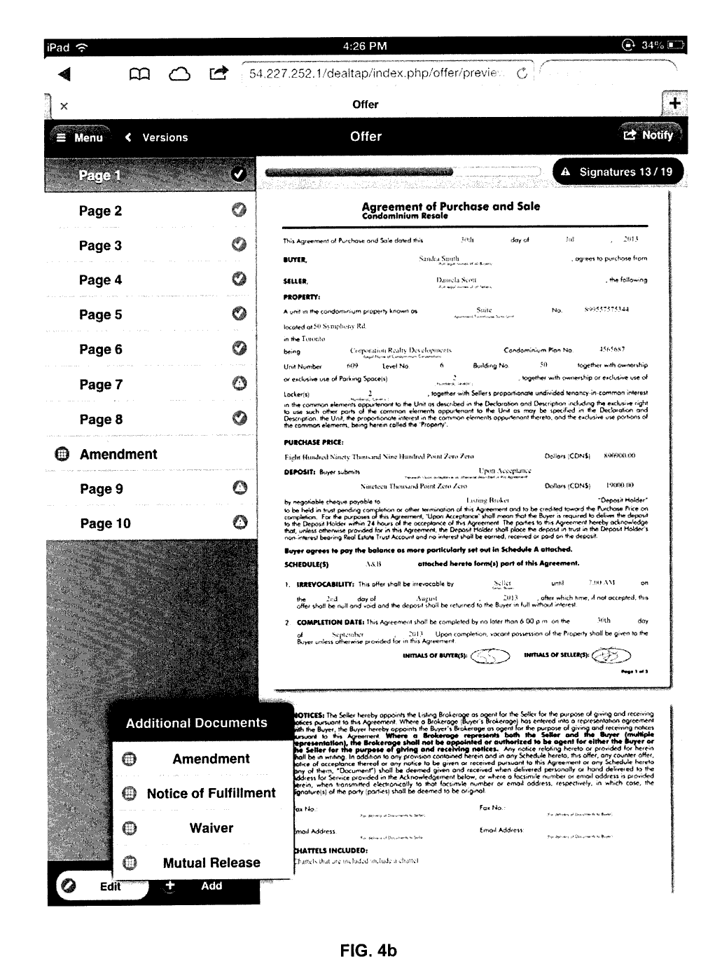

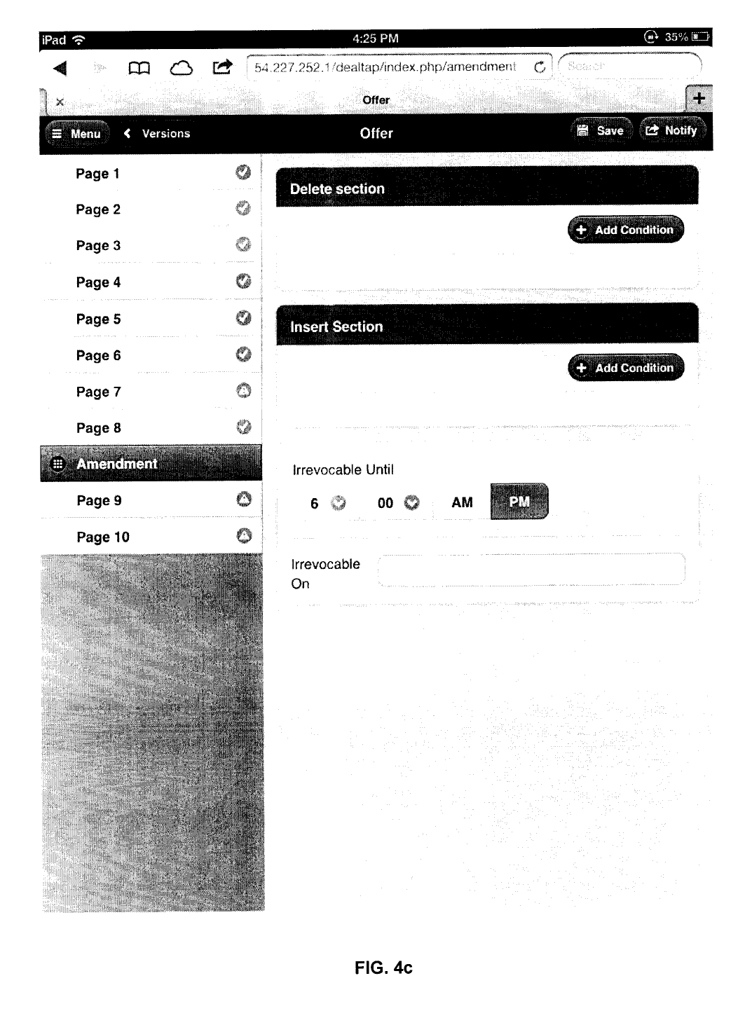

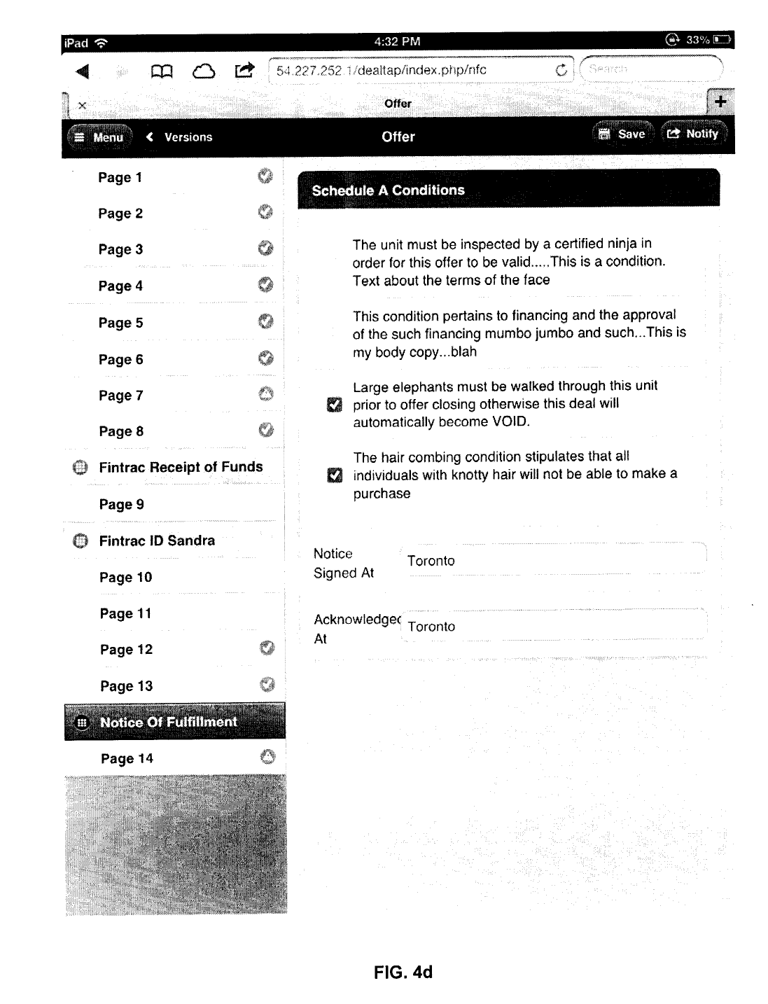

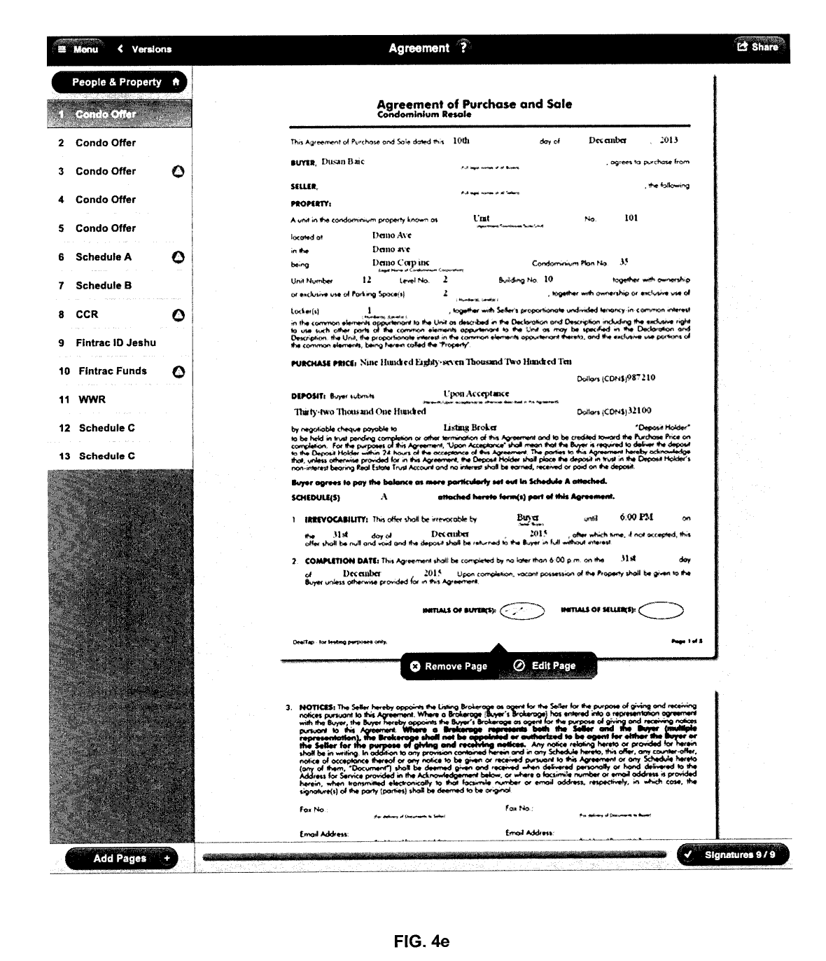

FIG. 4a shows that once a user clicks on a particular heading, in one implementation, only the pages relevant to the relevant transaction document (18) may be presented. In this view, as shown in FIG. 4a when a user clicks on a particular page, an image is displayed as described in this disclosure.

FIG. 4b also shows that a an “ADD” button can bring up a menu relevant to the particular transaction document (18) that includes other related documents for example an “AMENDMENT”. Selecting “AMENDMENT” adds this heading and related pages to the stack automatically. This triggers the screen shown in FIG. 4c which requires other information relevant to the “AMENDMENT” to be added. FIG. 4d shows similar functionality for other pages added to an offer.

These screens highlight the adaptive, flexible, and streamlined workflow of the present invention for building an offer easily and efficiently, despite a range of variables.

In another embodiment, the stack may be organized to present a set of vertical links, provided, for example, as rectangles, wherein each of the vertical links is linked to a specific page of a document. If the document has multiple pages, the title would be repeated (e.g. 1 Condo Offer, 2 Condo Offer). This embodiment may provide an intuitive interface for a user to easily navigate through the pages of documents on the interface, which may be advantageous when dealing with one or more documents having multiple pages, especially on a small interface such as those found on mobile devices. An illustrative screenshot, according to this embodiment of the invention may be seen in FIG. 4e.

A signature progress bar may also be seen for a particular document and its current state in FIGS. 4a and 4b. Additional views of the signature progress bar are shown in FIG. 5a.

The presentation of a transaction document (18) may include an image of the familiar paper based document, but with additional information such as overlay text and visual content indicating a location in the document that requires a signature for example. Clicking on the area of a displayed transaction document (18) that requires a signature or initial may bring up a window such as the screen shown in FIG. 5b. The screen shows a sign pad. Once signature is completed then this is uploaded to the platform (10) and processed.

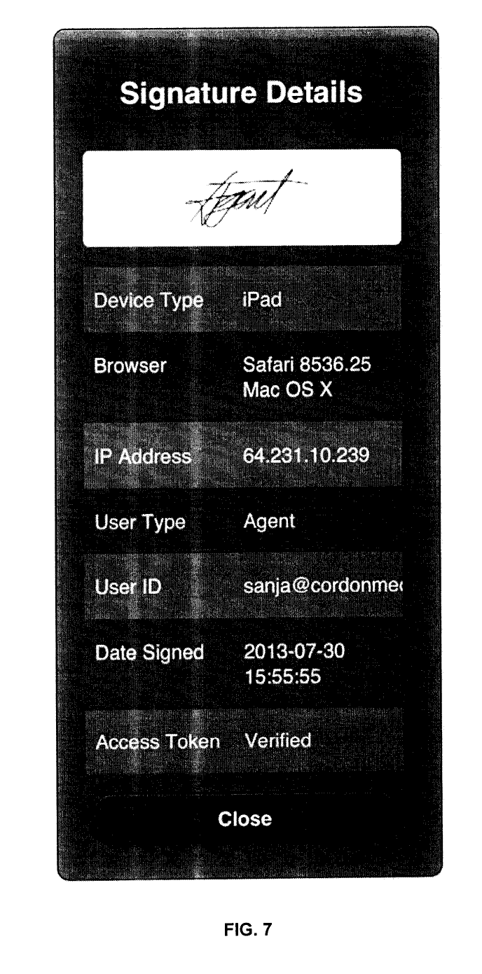

In another possible embodiment, as shown in FIG. 7 a signature screen my pop up showing other related parameters captured by the system for identifying the signor.

FIGS. 6a and 6b show possible embodiments of screens presented by the tracker utility (30). Rectangles representing an event such as an offer, and then different versions of subsequent counter-offers may be arranged in any order that aids in understanding the associated negotiation steps. For example, the most recent event may be shown at the top, and the earliest event at the bottom. Other events are arranged chronologically in between. The reverse arrangement is also possible. The date for each event and associated user information for the triggering the event may be shown. A button may be provided for accessing other information or related actions. For example, each step may be viewed thereby accessing the related information. In one aspect, a “PREVIEW AND MODIFY” option is only given for a rectangle that represents a stage of a transaction document (18) that permits for example modification. A new counter-offer renders an earlier counter-offer null and void, however, accessing the then state of the transaction document (18) may still be helpful, and also to see that this step had occurred in the tracker view helps understand the negotiation history or course of dealing very quickly.

FIGS. 6a and 6b also show that the various rectangles may be arranged in columns based on the parties or actors involved. For example there may be a seller column and a buyer column. There may be different arrangements or columns for different business segments. For example in insurance there may be a client, a broker, and an insurance company column. Also, additional columns may be provided for example for approvals. Different views of the tracker may be presented depending on the profile of the user.

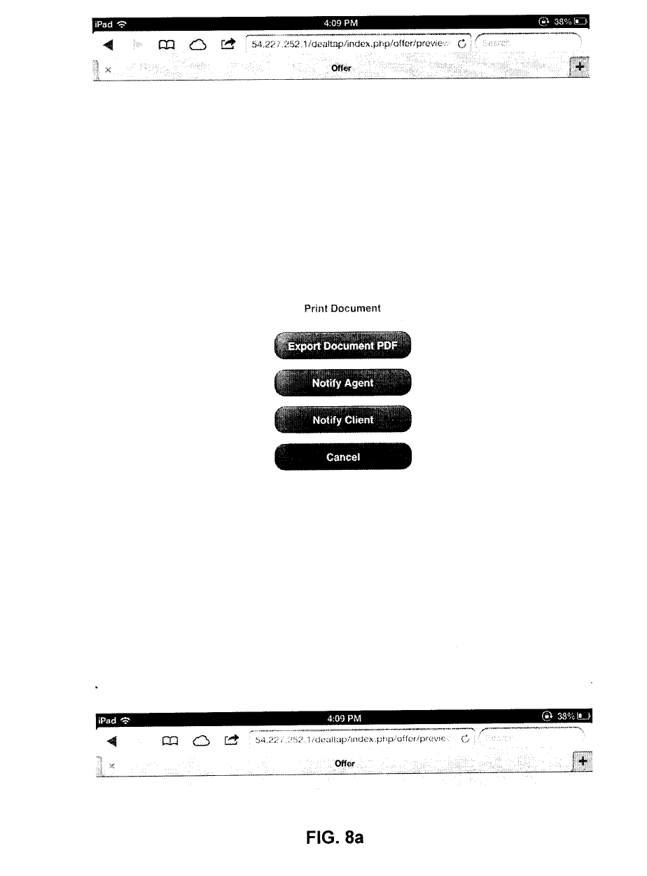

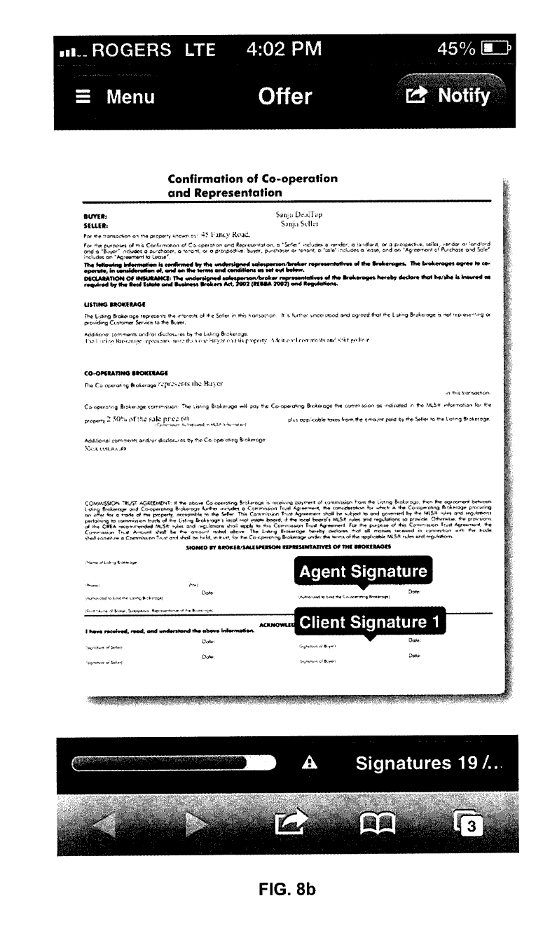

FIG. 8a shows a possible notification menu presented by the notification utility (52). FIG. 8b shows an example of what is presented to a client once they have been notified of an offer. They may be shown a preview version only that does not allow the client to make edits but highlights remaining actions, including actions required of them, in this case the requirement for their signature. The client may click on the signature area which triggers the signature utility (56) previously described. They too may then click the “NOTIFY” button which may automatically notify the agent that their signature has been obtained, or there may be other options also such as “EXPORT DOCUMENT PDF” which may allow the client to export a PDF of a signed version of the document for their records. The screen presented to the client may also include the progress bar.

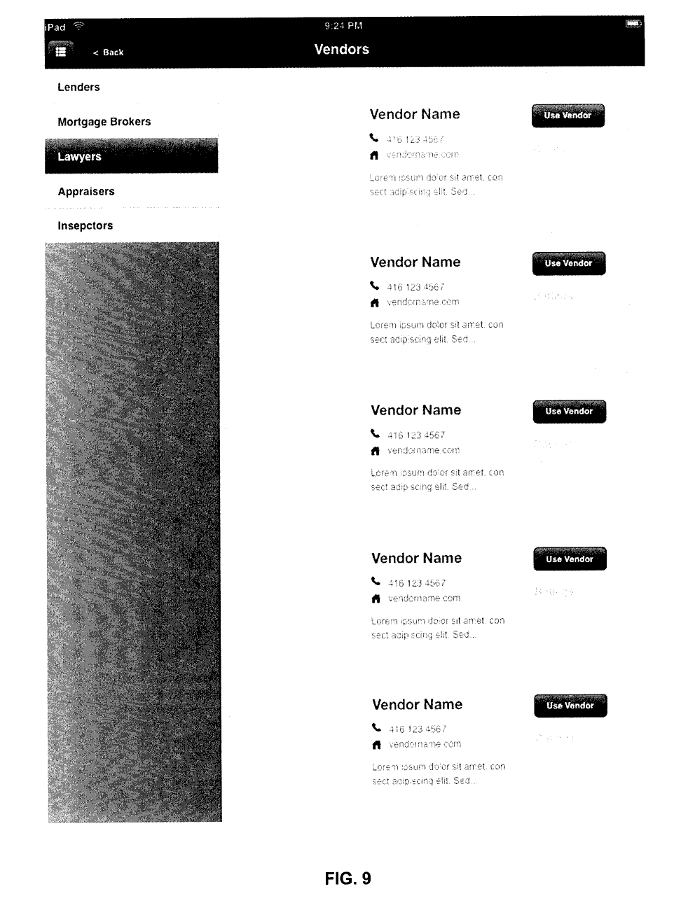

FIG. 9 shows a possible screen for a vendor list which may be maintained for example by a real estate agent user. Vendors may be arranged based on a category. The user may also trigger a search feature to find additional vendors through the platform for example using a “FIND MORE PROS” button or equivalent. In one aspect, the platform may include a matching utility of equivalent for suggesting possible connections between different users based on for example similar geography, similar business styles and so on. The analytics engine (32) may be used to perform intelligent matches.

The real estate agent user may also add a new vendor. Optionally, once a vendor is selected for example as a preferred vendor, then one or more forms or processes may automatically invoke that vendor. The real estate agent may also set certain rules such as using one vendor in one geographic area and another vendor in another geographic area.

Notification feature may also be extended to vendors.

In another possible embodiment, the user may be able to access edit/remove functionality on the preview version. Upon the interface detecting a click on an object on a particular page of a document, or upon the interface detecting a click on a view of a document, an edit input form may pop up for the appropriate page of the document.

In another possible embodiment, the interface may be configured to provide an overlay on the document, the overlay possibly being translucent or transparent, so that the user would be allowed to select a defined region of the form. Based upon the selected defined region of the form, a specific input field associated with that region may be provided. This, for example, provides funtionality that permits the overlaying of data on a form, even if the form is not an editable document. The form may further provide functionality to allow a user to select/modify the font face used, the font size, among other editing options. A potential advantage of having such a feature is that data may be appended to a document that is more consistent with the original formatting and style of the document, even if the document is not provided in an editable format (e.g. it is a scanned copy of an agreement).

Various other arrangements are possible.

### Targeting

The platform may include a targeting utility (64) that targets users with specific information or offers, based for example on the current state of a transaction workflow. The targeting utility (64) may also apply location based filtering. For example, the targeting utility (64) may provide offers from local inspectors once, based on the applicable transaction processes, the selection of an inspector is required. Automated targeting of users based on known requirements in connection with a current stage of a transaction provides a novel and innovative approach to advertising that provides high degree of relevant and acceptance from the clients.

Various other related features are possible. For example, agents may rate vendors for their clients. Clients may also rate vendors, thereby modifying their rating.

### Other Features

The platform may also include a profile manager (46) that stores the preferences for each user, and also their transaction history, to a user profile. The user profile may be updated from time to time, and may be used by the platform (10) to customize the content or resources presented to the user. The platform may include machine learning features that enable the discovery of user preferences, and on this basis present information or offers of interest, or filter information presented or offers made.

There are often different rules that determine the applicability of certain transaction processes. The transaction manager (12) may implement for example a series of logic rules, which may define a decision making tree, for determining the applicability of certain transaction processes, based for example of analysis of user input, or actions of a user on the platform (10). In one possible implementation, a web form may be presented to the user for inputting parameters associated with a transaction project. The web form for example may include one or more drop down menus, that based on the profile for the user suggest a number of parameters relevant for example to the business domain of the user. The parameters may trigger one or more actions of the platform (10), including for example: presentation of relevant transaction documents; automatically selecting derivatives of transaction documents (such as transaction documents including specific clauses addressing specific parameters); the platform (10) may automatically select and apply a particular set of transaction processes (16). For example, based on the parameters, certain additional requirements (such as approvals or additional forms) and so on may be required to complete a particular transaction. This aspect of the invention may streamline the transaction workflow, and also provide flexibility in addressing different transaction workflow variables, yet presenting only relevant transaction documents, and relevant transaction processes (16).

In one aspect of the present invention, geography for example may determine certain transaction processes (16). For example, in a real estate application of the present technology, a local real estate board may require certain transaction documents or certain negotiation rules (22). Similar jurisdiction based rules or practices may exist in other applications of the present technology. It can sometimes be quite challenging to keep abreast of all changes, and especially to ensure that all forms are up to date. Sometimes “legacy” transaction documents are used, which may result in certain transactions being unenforceable or requiring costly or time consuming corrective action. Such problems are avoided by central updating of the various relevant transaction processes (16).

In another aspect of the invention, the transaction manager (12) by relying on the analytics utility (32) may include various intelligent features that make the platform (10) adaptable to relevant contextual elements, including for example user input, variable transaction parameters, information relevant to a transaction (such as in the case of insurance, residence of a potential client, their employment etc.). This information may be used for example to feed a suggestion engine (48) that may suggest for example next best questions for the relevant user to consider. The suggestion engine (48) may also be used to suggest possible approaches to certain transaction processes (16). This may be relevant especially where there is significant user discretion. In one possible implementation, the suggestion engine (4) may analyze various parameters relevant to generating an insurance offer, and may auto-generate a suggested offer for modification of a user within one or more discretionary parameters.

Various other intelligent features are possible.

Increasingly, clients are on the move. Real estate clients for example may be trying to buy a vacation property in another jurisdiction. They may be entering into a rental agreement for their vacation. They may be trying to purchase a property in their home jurisdiction while they are on a work term in another jurisdiction. A sale of a home may require signatures from both spouses, but one spouse may be travelling on business. These situations, based on current solutions can cause significant logistical issues in obtaining signatures for example, resulting in delay. Similar problems exist in other business segments, particularly where currently wet signatures are required. The platform (10) provides an easy to use way to conclude transactions efficiently even when one or more participating users are in another location.

Even where signatures are not required, transactions often involve reviewing different documents. From a client perspective, the platform (10) may help clients keep all of the relevant documents, forms or other information in one location, rather than having to save them to a document management system or other software program, or find them in an email inbox. It is typical across a transaction for a client to be presented with variable options, some may be discarded and then may come back again. Negotiation may also be involved that results in further changes. It can be difficult and time consuming at different stages in a negotiation to try to review the history of the negotiation and even determine the current state of the negotiation and review the information and documents relevant to that current state. In one possible implementation, the platform (10), in a client view presented by the web presentment utility (26), depending on the preferences may present only the information and documents that is relevant on a current basis. The tracker utility (30), however, may be used for example to quickly see an overview of the course of dealings reflected across the transaction. The steps presented by the tracker utility (30) screen(s) may provide a link to earlier information, for example, an earlier offer that was rejected, or that was later changed. Accessing earlier information in this way provides a useful tool for reviewing history which may be of interest for example to determine whether a current offer is advantageous. Similar functionality may be provided for example to other types of users such as for example an agent or broker or other personnel involved in a transaction.

Various permissions may be assigned automatically by the platform (10) based for example on the type of user and the business segment. For example, in a real estate application of the platform (10), clients generally have the rights to review an offer, sign, and notify an agent. Clients do not generally have the right to edit an offer for example. They may be able to annotate an offer for example with requests or suggestions, and these may be presented to the agent, and the agent may incorporate these requests or suggestions as changes to the offer.

A broker or broker administrator user may also be defined, for example in a real estate context.

While the platform (10) may provide access to standard resources such as required transaction documents (18), various users may upload to the platform (10) and use in their business clauses, tools, documents, or business processes that belong to them and that may be proprietary to them. For example, the administrative utility (14) may be accessed by a user to establish settings for information, documents, or processes that are “personal” or that may be shared. Information, documents, or processes may be selectively shared.

In some embodiments, the platform (10) may include an optical character recognition (OCR) module. The OCR module can be configured to receive or access an image, .PDF, text or word processing document, or any other file, image or data in any format. This file, image or data can be selected, received and/or accessed via a user interface, email, FTP, camera application or device, or any other manner. The OCR module can display at least a portion of the received/accessed file or document and can provide an interface for selecting a portion or area of the file or document. Once the desired area is identified, the OCR module can be configured to convert the selected portion or area into live text using optical character recognition and/or any necessary image processing. The imported text can be parsed and/or sorted into individual negotiation points and adjustable clauses and/or conditions.

In some examples, the OCR module may allow for portions of text in an image or static document can be imported from paper documents or documents not directly compatible with the platform, and to permit their content to be changed within the platform without relying on the original tool used to create the original PDF/JPG/Word file. The imported clauses can also be linked into the workflow management and context provisioning of the platform.

The platform (10) may include a communication layer (50). The communication layer in one implementation processes various communications between users through the platform (10), including delivery of notifications.

Another aspect of the invention is that the communication layer (50) through the platform (10) may be used as the primary method of communication regarding a transaction. Notifications may be sent to external devices, but there is an advantage to centralizing all communications. Annotations of transaction documents (18) may be used as a preferred mechanism for example for a client and his/her agent to communicate in a way that is recorded and linked to the relevant transaction documents (18) and their current state. These annotations may implement chat type features where the annotations are recorded and displayed to each user such that the conversation in relation to a specific clause in a transaction document (18). This information may be presented in entirety, or a chat bubble may be displayed in a document view which if selected presents the relevant back and forth conversations including information such as sender, time, subject heading etc.

This may be preferable to emails for example regarding points which a client may not be able to properly evaluate without again referring to the document. If the document for example is attached to the email then this can fill in boxes and further this assumes that the agent has access to the document to be able to deliver it quickly at the relevant time. Often the agent does not have access to the document, so it is their back office that is sending out such information, which as stated elsewhere adds cost, and even so mistakes can occur by sending out a wrong version of a document. In the platform (10) the correct and current information is always accessible to permitted users.

The communication layer (50) may include social networking features or may link to a social networking platform, in order to enable social media interactions. The functions or features of a social networking platform may be used for example by users of the platform to stay in contact with clients or colleagues, and may be used in order to selectively determine social networks within which a user for example may share their information, documents, or processes.

In another aspect of the present invention, transaction documents (18) are negotiated in real time or near real time in the cloud.

In another possible aspect of the present invention, the security layer (28) incorporates one or more techniques for securing information so that seamless connectivity is possible to the platform (10), while maintaining security of the information.

In one possible implementation of the invention, the transaction documents (18) may be implemented as a series of HTML templates that are made to have the same or very similar appearance to associated paper based documents. In another possible implementation, an image is generated for each view of a transaction document. This image may be implemented as a time stamped image.

In another aspect, a coordinate based overlay is defined that maps to the transaction document (18) and permits a user to click on an area that overlaps for example with a field of the paper-based document (18) (“input area”). Clicking on such an area may bring up an input field, which permits a user to enter information. Alternatively, the transaction manager (12) may detect patterns and fill in information automatically if it is determined that the input field relates to information already provided, or already available. In one possible implementation, completion of fields suggested by the platform (10) may either be accepted, rejected, or modified.

In one implementation, the view of the transaction document (18) is time stamped, and identifiers are associated with each input area. Information is logged to the platform such that is encoded with the identifier for the input area, and also with information that identifies a particular view of a particular transaction document (18), at a particular time. This encoding of input to the platform (10) is used to provide version control, and to enforce the negotiation rules (22).

In another aspect of the invention, the profile for each user of the platform (10) defines the type of user that they are or their role in a transaction for example. User types may include for example “agent” or “client” in a real estate application.

The functions of the platform (10) depend on the relevant user type. For example, if an agent receives a link to an offer, it takes them to the offer in the platform (10). The associated client may receive a notification for the same offer. But the link generated by the platform (10) would take the client only to a preview of the offer.

The transaction processes (16) may define for example certain relationships between different transaction documents (18). For example, in a real estate application, the transaction processes (16) may only be added to the platform (10) or presented by the platform (10) once another transaction document (18) has already been negotiated and/or signed by all required parties. In one possible implementation, the platform (10) in presenting the current view of a transaction may only present transaction documents (18) that are relevant to the current state of the transaction. Various different embodiments are possible, for example the navigation pane (62) may present active transaction documents (18) in a manner that is highlighted, and separate and apart but possibly creating a lesser impression, additional documents may be shown such as “FINISHED DOCUMENTS” or “UPCOMING DOCUMENTS”. Various arrangements and features are possible. All of such features or functions are based on the ability of platform (10) to present or highlight the current state of a transaction involving in some cases several transaction documents with many associated requirements, which provides clarity, permits the user to focus on the information or tasks that are relevant at a particular stage without the need to be intimately aware with the steps of the transaction, and also without the need to review history or less relevant information or documents to determine or confirm the current state of the transaction. Given the configuration of the platform (10) described, users (with their particular context or settings) are assured that the information that is presented to them always reflects the current state thus streamlining the workflows implemented to the platform (10) significantly.

In another possible implementation, transaction documents (18) that are mandatory at a particular time may be edited and other transaction documents (18) that are not currently mandatory may be disabled.

Accordingly, the platform (10) is dynamic in its operations and its presentation of information. Further, as previously described it is also adaptive relative to the current state of a transaction and also the context of the various users accessing the platform (10).

In another possible aspect, within the parameters set by the transaction processes (16), users are able to use the preferences utility (38) to make changes to certain aspects of workflow or presentation of information that suits their preferences for participating in a transaction. For example, some clients may want to review all information in detail, other clients may want to set certain filters designed to allow them to define their tolerance of risk or the time that they want to spend reviewing information relevant to the transaction. Some clients want to review everything, and others want a summary of key terms that are of interest to them. And other clients are in between. Using the platform (10), the client may initially or at any time use a screen presented by the preferences utility (38) to record their preferred approach. Thereafter, the presentation of transaction documents (18) and related information such as annotations or suggestions may be guided by these preferences.

Alternatively, different users providing services to clients through the platform (10) may have different styles or approaches. These differences may be important to their ability to attract and service clients effectively. In many prior art solutions, users would ordinarily have to spend time and money configuring standard solutions to their requirements, or adapt to processes defined by standard solutions that may not suit their style or preferred processes. The platform (10) is designed to permit certain flexibility. For example, real estate agents using the platform (10) in a real estate use of the technology may automatically use preferred clauses, and create their own annotations or forms for highlighting most important information for their clients. Various other such features are possible.

In another possible aspect, some users (such as an agent) can upload to the platform (10) particular documents or forms that they want to use. The platform (10) may include an import utility or equivalent that helps select the fields associated with a form for example and the parameters for logging information associated with those forms. The platform (10) automatically encodes the location of the fields, and data elements identifying specific fields for storing information inputted to the form in association with related database records in the database (40). These input functions allow a user to easily deploy a new form to the platform (10) that uses the viewing/data entry features described elsewhere.

The CRM (54) may include various features or functions ordinarily associated with a CRM. Also, the CRM (54) may be implemented as a third party CRM platform that integrates with the platform (10).

Various specific functions or features may be included that are directed to particular types of users, in particular business segments.

For example, in a real estate application of the present invention, the web presentment utility (26) may present an “offer list” screen to a real estate agent that helps them track the various offers that the agent is currently part of. Offers may be filtered for example based on “ALL”, “REGISTERED”, “PENDING”, “COMPLETED” and “FALLEN THROUGH”. Basic information may be provided regarding an offer such as the address of the property, the client name, the date of creation of the offer or other information. The agent may click on an offer to access additional information. A “NEW OFFER” button may allow the agent to create a new offer and provide information related to that offer.

Various other feature may be added to the tracker utility (30). For example, a real estate agent user may indicate whether a deal if firm or not. If a deal is firm, then a notification may be sent automatically to the brokerage administrator.

Other notification features are possible depending on the business segment and user preferences. For example, while the platform (10) in part decreases reliance on administrative staff certain functions such as calling banks, preparing cheques, making sure keys are available and so on may still need involvement of administrative staff. A “NOTIFY ADMINSTRATOR” feature may also be provided which allows a real estate agent user to trigger involvement of administrator or some other resource outside of the platform features once this is required.

In some aspects of the invention, the server computer (11) may also maintain data points stored into databases (40 and 13), the data points storing information captured by the system, such as deposit amounts, clause conditions, dates, clause modifications, addresses, names, free text information (e.g. information received but not well-mapped to a particular field) and names, among others.

The data points may be maintained throughout the transaction process and possibly afterwards, with the server computer (11) also provide an application programming interface (API) for communicating this data with other systems, such as land registries, accounting software, etc. The data may be transmitted along with other metadata or information generated to provide relevance as to what the data is and how it can be used.

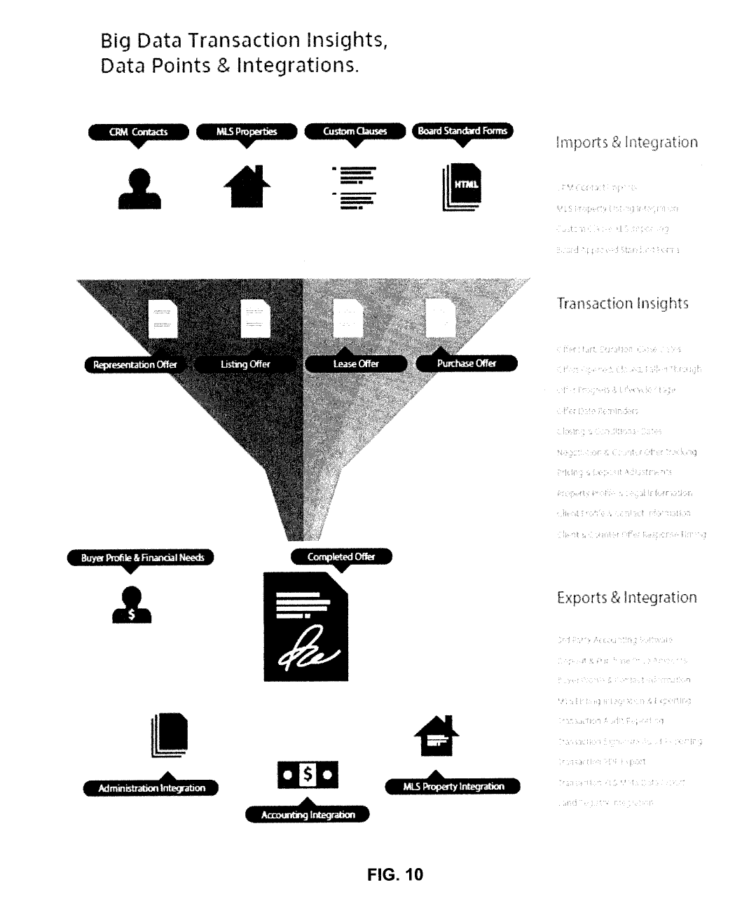

The data may also be received by the system using an API, which may be used in various ways by the system, for example and not limited to, pre-population of fields, map development, verification of information (e.g. name is spelled differently on land registry), providing the data to decision support tools (e.g. this property has an easement registered on it), etc. A sample illustration of an embodiment of the invention is shown in FIG. 10, where various elements of information being fed through the system and being provided further to various systems, including administrative integration systems, accounting integration systems and MLS property integration systems. While it is not shown in this particular illustration, information may also be provided from the various external systems to the system of the invention.

### Implementation

One possible implementation of the present invention is shown in FIG. 1a and already referenced above. Various other possible computer network architectures are possible.

FIG. 1b presents an additional possible implementation of the present invention. In one possible implementation a first web server or set of web servers support access to the platform from a desktop computer or tablet computers. Agents, brokers, and vendors will generally access the platform (10) using a desktop computer or more typically a tablet computer. An agent module, brokerage module and vendor module may be implemented to a first web server. Clients are most likely to access functions or features assigned to them either through a desktop computer or tablet computer, but possibly more often from a mobile device. A second web server therefore may host a mobile version of the server computer program that is designed to present the functionality described to mobile devices, for example by facilitating connections between a mobile device and the second web server so as to provide access functions and features of the platform (10) using a mobile browser on the mobile device.

A device management module implemented on each web server may enable the platform (10) to provide a consistent user experience across different types of devices.

In one possible embodiment a mobile client may also be provided that connects to the web server but may also improve performance and enhance user experience on the mobile devices.

Various other implementations are possible.

### Analytics

In one aspect of the invention, the platform (10) may be configured to log various information or events, and this data may be made accessible to an analytics engine (32). The analytics engine (32) may be configured to feed a reporting utility that may generate various reports. Access to the analytics engine (32) and specific reports from the reporting utility may be controlled and managed by operation of the administrative utility (14).

The analytics engine (32) may further be configured to apply statistical analysis and/or data mining techniques to potentially identify trends and correlations; for data cleansing/verification; for various reporting and/or predictive purposes; and to provide decision support capabilities. The analytics engine (32) may, for example, be able to provide agent performance profiling, broker performance profiling, client profiling for required post-transaction services (e.g. providing information to aid banks providing mortgages, lawyers), enforcing compliance, identifying best practices, overall profiling of demographic, socioeconomic or geographic factors, etc.

The analytics engine (32) may utilize data received across a subset of users or transactions, or may utilize data received across sets of population in conducting its analysis. For example, analysis may be conducted at the level of an individual (e.g. a broker wishes to see where he/she can improve his/her own performance), level of an individual brokerage (e.g. the brokerage is interested in tracking the performance of its agents or interested in determining where the process may be streamlined), or at the level of an entire geographic region or population (e.g. there were an increased number of transactions in the Regent Park neighborhood, however, a number of these transactions did not conclude as they were stalled in negotiations over differences in purchase price expectations between buyers and sellers; or the presence of a newly built subway station increased average house prices within a certain radius).

Examples of possible metrics generated by the analytics engine (32) may include, in a real estate application of the platform (10): (i) click through information for a particular agent's account; (ii) number of times that a real estate agent's profile was viewed; (iii) number of times that their profile was selected; (iv) number of impressions; (v) reviews of various transaction documents, and so on.

Such metrics may be used for example by a real estate agent to manage their business; or a broker to track relative performance of agents. In an insurance context, metrics may be analyzed to generate insights for optimizing offers to maximize acceptance, improve workflows, evaluate performance, improve risk management, and so on.

The analytics engine (32) may implement various analytics applications and/or analytical processes. The analytics engine (32) may include a semantic analyzer for example for analyzing semantically for example text captured from various communications that are part of the social media interactions initiated using the social networking environment (104) of the present invention. Various data may be logged by the platform (10) and then made accessible to the analytics engine (122) in order to feed a number of insights. Examples may include: identifying best practices (such as providing explanations as to why certain personnel using the platform have better results), establishing richer user profiles and thereby enabling better matching of users in connection with transactions, identifying opportunities for streamlining processes, identifying opportunities for tailoring compensation to work required in specific transactions, and so on.

### Example in Operation

The operation of the invention may be illustrated in a specific use case. The use case also illustrates possible workflows based on the present invention.

One possible example in operation is a use of the platform (10) in conjunction with a real estate transaction.

An agent user of the platform (10) may already have a client who is registered to the platform (10). The agent user may assemble or import details concerning one or more properties for example using listing information from a third party or in fact another user of the platform (10) who may be a listing agent.

The client user may browse through properties in the platform (10) but selected for the client user by his or her agent. The client may indicate his or her interest in a particular property. The client and agent may communicate through the platform (10); these communications may be reflected as annotations to listing information presented by the platform (10). Even in relation to pre-offer information, the agent and client can always view the current information and also a record of their communications and exchanges related to the records.

The client may reach a point that he or she wants to make an offer. The agent logs into the platform (10) and creates the offer, as described. Certain aspects of the offer may be pre-populated such as property description (may be pulled from listing information). The offer once prepared is automatically distributed to the client. The client can view the offer, and can ask questions or comments as annotations. These are presented to the agent in a way that the comments or annotations are associated with relevant parts of the offer. This link to a document that the real estate agent is familiar with streamlines the workflow and avoids confusion for example as to which condition a client comment relates to.

Once accepted, the agent and the client sign the digital document.

The offer is then forwarded through the platform to a cooperating agent who may be a user of the platform, or the cooperating agent may be invited to join the platform. If the cooperating agent is a user of the platform, the offer again may be reviewed through the platform and may be annotated for review by his or her client. The offer is presented to the client of the cooperating agent for review and/signature, including by notification to the mobile device of the client. Preferably the client of the cooperating agent is also a user of the platform permitting actions to happen on the server.

The client can either sign, including on his or her mobile device. Or he or she may indicate that he or she wants changes, i.e. a counter-offer to be made, in which case this is communicated through the platform to the cooperating agent. The cooperating agent may then amend the offer and send it through to the other agent.

This process may repeat itself, but the various actions occur through the platform and therefore negotiation rules are enforced automatically, and each participating user can easily track where they are in the negotiation. Also, the platform and its operations establish trust between the parties in the negotiation process.

The process for facilitating an insurance contract is similar in some ways. A broker collects information from his client, and this may be submitted to one or more insurance companies through the platform. The platform (10) may also include a facility for sending certain information to a company that is not using the platform (10) however in this case users will not benefit from the full range of functions and features.

Different companies may have different processes or rules as to what analysis is done to determine an appropriate insurance quote, based on what parameters and by whom. Various forms or documents may exist for providing information, reviewing information, and obtaining approval for example for compliance purposes. This process can be streamlined by the present invention by automating processes and ensuring that all relevant information is available. Also, the platform may integrate with third party system for example for approval processes, risk scoring, generation of aspects of a quote and so on.

Also, it may be that an initial offer is made, rejected by the broker or the client, resulting in a different offer (possibly for a different price but also different coverage). In other words there may be significant back and forth in the insurance context as well.

In one aspect, the broker may evaluate several different quotes from different companies and annotate these and present them to the client. Again, having all information in one place, and possibly annotations made to documents directly in the relevant portions thereof can help streamline the process. The broker may also have standard annotations for contracts from particular insurance companies. Rather than discussing these clauses with the client, the broker can pull standard comments and also quickly customize these based on issues particular to the client.

Eventually, a quotation may be accepted by signing it, and an insurance agreement can also be signed through the platform.

For insurance companies ensuring that proper steps have been followed in ensuring that various formalities related to the agreements have been followed, such as for example that there was valid acceptance by the policy holders, may be critical. Specifically, it may be necessary to “prove” acceptance of all essential elements of the contract. Otherwise the insurance company may be in breach of regulatory requirements and also limitations to coverage may not be enforceable. The platform streamlines the processes that are normally involved in ensuring that such regulatory requirements are met.

The tracker utility (30) for example, in an insurance version of the platform (10) may provide an audit trail viewing utility for verifying steps required for example from an audit perspective. Also, the tracker utility (30) may feed information to an external computer system with auditing features.

In some embodiments of the invention, the tracker utility (30) may be configured to, upon detecting that an agreement is complete, export an audit trail that documents one or more of the actions performed by all users and collaborators on agreement throughout the agreement's lifecycle. This audit trail may include, for example, actions taken such as documents opened, saved, notified, edited, signed, and the actions may be time stamped and verifications recorded with regards to user accounts, signatures, PINs/passwords, etc.

In some embodiments of the invention, the audit report may also be configured to comprise a ‘signature audit’ that may review signatures to verify and validate signatures. In an illustrative non-limiting example of an implementation, the signature utility (56) may be configured to reviews one or more signatures, which may be selected randomly, for each collaborator throughout the agreement lifecycle and provide a comparison of them. The comparison may be conducted automatically or manually and may be provided, for example as a side-by-side comparison for visual inspection, and other characteristics, such as IP address, device, browser, etc, may also be considered.

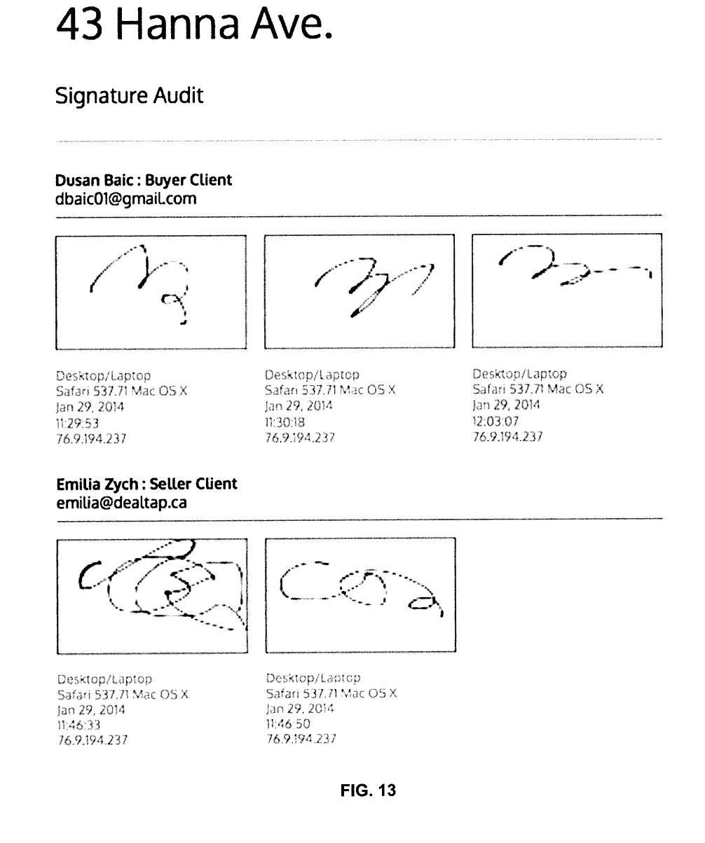

FIG. 13 provides a screenshot illustrating an example comparison of a plurality of signatures for two individuals, according to some embodiments of the invention;

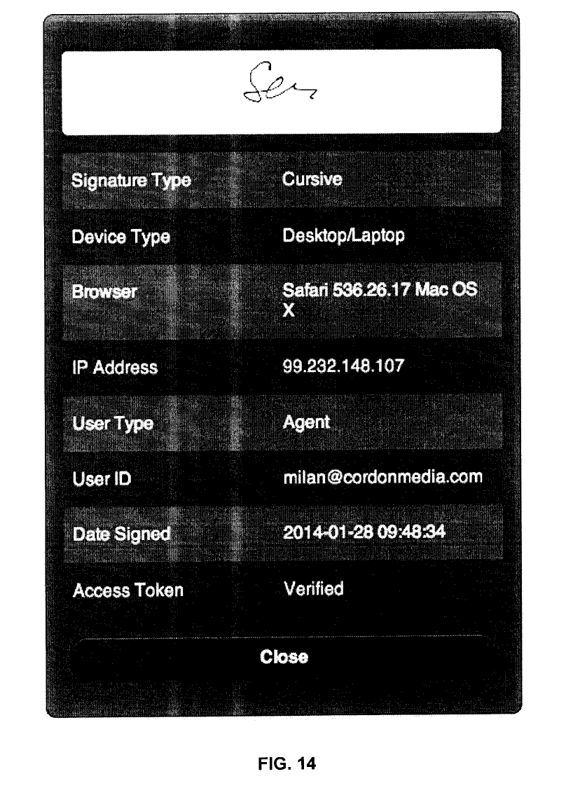

FIG. 14 provides a screenshot of the graphical user interface providing information related to a signature, according to some embodiments of the invention;

With some modifications, the platform (10) may be used for rental agreements, brokerage agreements, non-disclosure agreements, mortgage contracts, credit applications, grant applications, student loan applications, and so on.

The platform (10) is suited to any domain where there may be a contract management component.

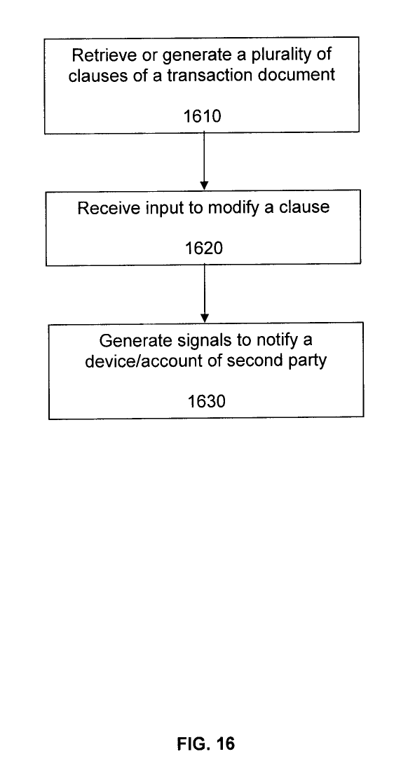

FIG. 16 shows a flowchart showing aspects of an example method for managing one or more transaction documents. Aspects of this method can, in some examples, be performed using one or more processors on one or more client devices, one a server or cloud device, or any combination thereof.

At 1610, the processor(s) can be configured to generate, retrieve or otherwise access a transaction data set including a plurality of clauses in one or more transaction documents. The transaction data set can, in some examples, be associated with one or more transaction rules for managing workflow. In some examples, some of the transaction rules can be based at least in part on the type of transaction document. For example, the transaction rules can be based on whether the transaction document(s) have a type associated with a real estate transaction, an insurance transaction, a banking transaction, or related to a transaction for other industries, business segments, or subcategories. In some examples, the transaction rules can be associated with a particular transaction, a particular transaction document, or with a template from which the transaction data set was created.

The transaction rules can, in some examples, define workflow(s) for managing the transaction documents. For example, the transaction rules may include rules defining which fields, clauses or acceptance inputs in a transaction document are required to constitute a valid or complete document. In some examples, the transaction rules may include rules defining the role(s) parties may play in a transaction and the viewing or modification permissions for each role. Other transaction rules can be associated with the transaction documents or transaction data set to help manage any of the workflows described herein or otherwise.

At 1620, the processor(s) can be configured to receive input(s) to modify at least one of the clauses of the one or more transaction documents. The input(s) can, in some examples, be received at or via a device associated with a first party to the transaction; or on, via or otherwise using an account associated with the first party (e.g. a browser session wherein the first party is logged into the system). In some examples, the input(s) can received from an input device on or connected to a device associated with the first party including, but not limited to a keyboard, a touchscreen, a mouse, or any other input device. In some examples, the input(s) can be received at the server from the device or account associated with the first party.

In some examples, the input(s) can identify modification(s) (including additions, deletions, edits, rearrangements, etc.) to the entire text or one or more aspects (e.g. a portion, a field) of one or more clauses. The processor(s) can, in some examples, be configured to verify that the modification(s) satisfies criteria established by the transaction rule(s), and when the modification(s) do not satisfy the rule(s), the processor(s) can be configured to prevent submission of the modification(s) and generate signals to cause display a notification of the unsatisfactory clause(s). These notification(s) can, in some examples, be proximate to or directly identified on the unsatisfactory clause(s) (e.g. by highlighting or otherwise).

In some examples, upon receipt of the modification input(s), the processor(s) can be configured to display the transaction document with the modified clause(s) along with interface element(s) at each position/clause/aspect/page which based on the transaction rules requires a signature, initial or other acceptance input from the first party. For example, a button, a field or an area of the document can receive an acceptance input, or can be activated to display another interface for receiving an acceptance input.

In some examples, the transaction rules may indicate that a signature field (another example acceptance input field) at the bottom of the document must be signed or resigned in view of the modification input(s).

In some examples, the processor(s) may be configured to not submit or accept submission of the modification(s) until each required acceptance input(s) has been received.

At 1630, the processor(s) can be configured to generate signals to notify a device or account associated with a second party of the transaction who is required to accept at least one aspect of modified clause(s). In some examples, the notification can be an email, text, application-specific or other message sent to an account, application or device associated with the second party. In some examples, the notification can be shown on an interface screen when the transaction document(s) or a welcome screen is displayed on a device or via an account associated with the second party.

In some examples, based on the transaction rule(s), the processor(s) can be configured to generate signals to notify device(s) or account(s) associated with every party in the transaction, or every party who is required to accept or who may have an interest in the modification(s). In this manner, in some embodiments, the system can allow for multiple parties to accept terms of a transaction document concurrently, on different device(s), and/or in different location(s).

In some examples, the processor(s) can be configured to display the transaction document with the modified clause(s) along with interface element(s) at each position/clause/aspect/page which based on the transaction rules requires a signature, initial or other acceptance input from the second party. For example, a button, a field or an area of the document can receive an acceptance input, or can be activated to display another interface for receiving an acceptance input such as an inputted written signature or initials.

In some examples, instead of acceptance input(s) for a particular modification, the processor(s) can be configured to receive counter offer term(s) or aspect(s).

In some examples, when receiving acceptance input(s) the processor(s) can be configured to display a count (e.g. 5 of 20), completion rate (e.g. 25%), status bar or other interface element for communicating how many modifications, notes or annotations have been accepted or acknowledged.

In some examples, the processor(s) can be configured to receive/collect audit data associated with one or more of the acceptance input(s). This data can include, for example, an identifier associated with the device on which the input was received, a location of the device on which the input was received, an IP address of the device on which the input was received, an application or browser via which the input was received, the date and time that the input was received, and the verification status of a token used to verify the user on the device on which the input was received, or any other collectable data suitable for audit purposes.

In some examples, the processor(s) can be configured to verify the authenticity of the received input based on the audit data and data associated with the accepting party.

Upon receipt of an acceptance or counter offer input from the device or account associated with the second party, in some examples, the processor(s) can be configured to prevent submission of the acceptance or counter offer input unless an acceptance input or counter term input has been received for each aspect modified by the first party.

In some examples, the processor(s) can be configured to display a summary interface including each offer and counteroffer which has been proposed and submitted by the transaction parties. In some examples, the summary interface can include a summary of the main terms or modifications of each of the offers and counteroffers. In some examples, the summary interface can be displayed as a flowchart or chat-like interface which in some examples can provide a snapshot of the chronology of the back and forth negotiations between the parties.

As described herein and otherwise, in some examples, the processor(s) can be configured to display a transaction document and/or aspects modified by the first party on a device or via an account not associated with the second party who is required to accept the modifications. Upon receipt of an input to accept or counter the modified aspect(s), the processor(s) can be configured to send a verification code to an account or device (e.g. email address, text message, etc) associated with the second party. Upon receipt of this code on the device/account not associated with the second party, the processor(s) can be configured to accept an acceptance input or counter term input from the second party on the device/account not associated with the second party.

In some examples, this may allow a third party such as an agent to present the modifications to the second party on the agent's device or via the agent's account. In order to eliminate the need for the second party to log in or access his/her account on a separate device, the verification code can verify that the person accepting or countering the modifications displayed on the agent's device is actually the second party.

### Applications

In a real estate application of the present invention, for example, some embodiments of the platform (10) may provide a number of benefits. For example, agents may not have to spend as much time driving to meet clients to distribute paperwork and collect signatures.

Especially in domains where transactions are affected by timelines or deadlines, some platform embodiments may provide greater efficiencies which may make timelines or deadlines easier to meet. In a real estate application for example, where there may be competitive bids, delays because of preparation of documents and collection of signatures may result in a loss of a deal.

Workflow can be interrupted from time to time by such matters as lost documents, signatories that cannot be located, fax machines that break down and so on. These problems can be avoided by some embodiments of the platform.

In some embodiments, various transaction documents (18) may be viewed and edited on any device, such as a smart phone, tablet computer or laptop.

In some embodiments, various users can learn about new events in a transaction quickly or immediately, and can in some examples, access relevant information even when they are on the move.

Transaction documents (18) such as documents may, in some examples, be composed in the cloud, based on directions given using a mobile device only. Delivery of such transaction documents (18) may also be initiated by a mobile device, by initiating the platform (10) to provide a notification to other users through a variety of communication means.

Multiple parties can sign transaction documents (18), regardless of their location. In some examples, documents can be protected and can also be signed using any device, including a smart phone, tablet computer or laptop computer.

In some examples, the system can automate the tracking of requirements such as signatures, and can automatically generate updates to some users, and reminders to users whose action may still be required. Various escalation processes may be implemented to the platform (10), and these may be modified depending on the user or the transaction. For example, if a signature is time sensitive, then a real estate agent for example may launch settings that initiate escalating reminder communications if a defined period of time passes and a client has not yet signed a transaction document (18). Users such as a real estate agent may for example set in a client's profile very specific communication and escalation preferences, which the platform uses automatically. In one aspect, these may be set for example to be specific to different stages of a transaction. Also, the platform permits such settings to be varied depending on the signatory of a document for example. This is important, because particularly in time sensitive transactions or transactions where signing one or more transaction documents may be time sensitive, the preferred mechanism of having a user act on information or sign a document may vary. In repeat transactions where the signature of documents by the same individual are required time and time again, the platform may learn behavior of a signatory and automatically adjust communication parameters to maximize the triggering of actions on the user's part. The platform may also connect to third party systems such as for example electronic calendars in order to enhance these features.

The platform (10) streamlines workflows in a number of ways. In some examples, time (usually of clerks or secretaries) can be reduced significantly in regards to preparation of various documents such as a real estate offer or insurance coverage offer.

The platform (10) can, in some examples, inherently ensure that personnel are working in the context of an electronic workflow. It may, in some examples, be easier to monitor this workflow and discover or apply/enforce best practices, service improvements, audit trails or regulatory compliance processes, without significant additional work.

### General

Depending on the particular implementation and various associated factors such as the resources of the mobile device, wireless network parameters, and requirements of the content distribution of social media platforms, different implementation architectures may be used for the present invention.

It should also be understood that the server (20) may be implemented as one or more servers in any possible server architecture or configuration including for example in a distributed server architecture, a server farm, or a cloud based computing environment.

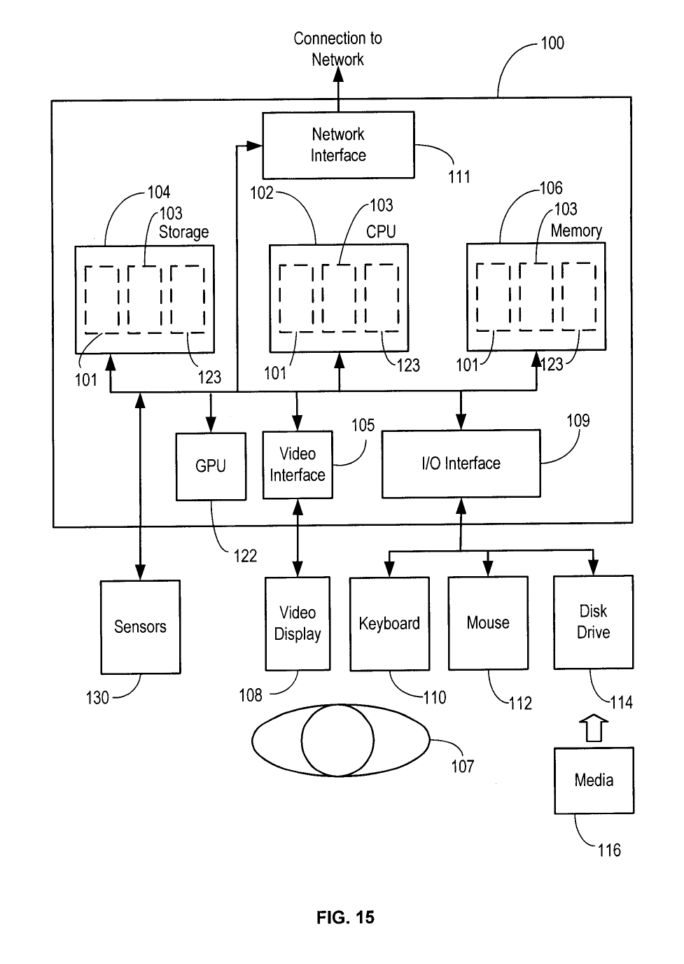

The present system and method may be practiced in various embodiments. A suitably configured computer device, and associated communications networks, devices, software and firmware may provide a platform for enabling one or more embodiments as described above. By way of example, FIG. 15 shows a generic computer device 100 that may include a processor or central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

Various functions described may be made accessible using one or more mobile devices, including by providing a mobile application for accessing features of the computer network service described, or accessing the computer network service using a mobile browser. The mobile application described may be implemented to any mobile platform, including the iOS platform, ANDROID™, WINDOWS™ or BLACKBERRY™.

It will be appreciated by those skilled in the art that other variations of the embodiments described herein may also be practiced without departing from the scope of the invention. Other modifications are therefore possible.

A skilled reader will recognize that other example various extensions to the features and functions described are possible, such as incorporate of various semantic analysis functions to the analytics engine (122).

It will also be appreciated that the block configurations, screen shots, and flow charts provided herein are for illustrative purposes only and various modifications thereof are applicable within the principles discussed herein.

Although the above principles have been described with reference to certain specific embodiments, various modifications thereof will be apparent to those skilled in the art without departing from the scope of the invention and the claims appended hereto. Other modifications are therefore possible.

1. A method for managing transaction documents, the method comprising:
generating or accessing, at at least one processor, a transaction data set including a plurality of clauses in a transaction document, the transaction data set associated with at least one transaction rule for managing workflow based at least in part on a type of the transaction document;
receiving, via a device or account associated with a first party of the transaction, an input to modify at least one of the plurality of clauses; and
based on the at least one transaction rule, generating signals to notify a device or account associated with a second party of the transaction who is required to accept at least one aspect of each of the modified clauses.

2. The method of claim 1, comprising: generating signals to notify a device or account associated with every other party of the transaction who is required to accept the at least one aspect of each of the modified clauses.

3. The method of claim 1, wherein, generating signals to notify the device or account associated with the second party, comprises generating signals to display the transaction document including the modified clauses and an area for receiving an acceptance input for each of the at least one aspect of each of the modified clauses.

4. The method of claim 3 comprising receiving an input representing a written acceptance for at least one aspect.

5. The method of claim 4, wherein the input is received via a touchscreen, mouse or other input device.

6. The method of claim 4 comprising receiving audit data associated with the input representing the written acceptance for the at least one aspect, the audit data including at least one of: an identifier associated with the device on which the input was received, a location of the device on which the input was received, an IP address of the device on which the input was received, an application or browser via which the input was received, the date and time that the input was received, and the verification status of a token used to verify the user on the device on which the input was received.

7. The method of claim 6 comprising: verifying the authenticity of the received input based on the audit data.

8. The method of claim 3 wherein the input represents an initial or signature of the second party.

9. The method of claim 1, wherein the input to modify at least one of the plurality of clauses includes data to verify that an acceptance input for each of the at least one aspect of each of the modified clauses has been received from the first party.

10. The method of claim 1 comprising:
upon determining that the input to modify the at least one of the plurality of clauses does not satisfy at least one of the at least one transaction rule, preventing the modification of the at least one unsatisfactory clause, and generating signals to cause display of a notification proximate to a display of the unsatisfactory clause.

11. The method of claim 1 comprising:
upon receipt of an acceptance or counter offer of the modifications via a device or account associated with the second party, preventing submission of the acceptance or counter offer input unless an acceptance input or counter term input has been received for each aspect of each of the clauses modified by the first party.

12. The method of claim 1 comprising: displaying, on a display, a summary interface including each offer and counteroffer proposed the parties to the transaction.

13. The method of claim 12, wherein the summary interface includes a chronological summary of the main terms or modifications of each of the offers and counteroffers.

14. The method of claim 3, comprising: displaying an interface element indicating a completion rate of the modified aspects for which an acceptance input or counter term input has been received.

15. The method of claim 1 comprising:
displaying, via a device or account not associated with the second party, an aspect modified by the first party;
upon receipt of an input to accept or counter the modified aspect on behalf of the second party on the device or account not associated with the second party, sending a verification code to an account or device associated with the second party; and
requiring an input of the verification code on the device or account not associated with the second party before accepting the input to accept or counter the modified aspect.

16. The method of claim 1, wherein receiving the input to modify the at least one of the plurality of clauses comprises: receiving a text or image file; parsing the text or image file; and identifying modifications or new clauses based on the parsed text or image file.

17. The method of claim 1, wherein at least one of the at least one transaction rule indicates that an expiry time or irrevocable clause would be violated by the modifications, preventing submission of the modifications.

18. The method of claim 1, wherein the at least one transaction rule defines relationships of parties to the transaction document, and controls access to aspects of the transaction data set by a device or account associated with a particular party based on the particular party's relationship.

19. The method of claim 1, wherein the at least one transaction rule defines relationships between different clauses in the transaction document, and wherein based on the relationships, modification of a first clause causes modification to a related clause and optionally requires acceptance of the modification of the first clause and of the related clause.

20. The method of claim 1, comprising receiving an annotation input from a device or account associated with a third party who is associated with the second party; and displaying annotation data from the annotation input in conjunction with a modified aspect on the device or account associated with the second party.

21. The method of claim 1, comprising: based on the at least one transaction rule, automatically generating an additional transaction document associated with a modified aspect or a state of the transaction data set.

22. A system for managing a transaction document for a transaction, the system comprising:
a server comprising at least one processor; and
one or more devices associated with parties to the transaction or via which parties to the transaction can log into their respective accounts, each of the one or more devices comprising at least one processor;
wherein one or more of the processors on the server and the one or more devices is configured to perform the method of claim 1.

23. A system for managing one or more workflows associated with negotiating and concluding transaction documents comprising:
a. a plurality of computer terminals linked to a computer network, including computer terminals that are mobile devices, each computer terminal associated with an individual; and
b. one or more computers executing a computerized transaction workflow management system that provides a computer network that when executed enables:
i. interaction of users with transaction documents based on their permissions, based on their role in a transaction;
ii. negotiation of transaction documents between parties to the transaction by enforcing a series of negotiation rules associated with the transaction, while allowing the parties to view and sign transaction documents related to the transaction securely using the computer service; and
iii. tracking actions in relation to the negotiation and conclusion of transaction documents for the purposes of automatically generating information regarding the current status of negotiation and optionally also to generate audit information.
